(19) United States
(12) Patent Application Publication
(10) Pub. No.: US 2024/0274860 A1
(43) Pub. Date: Aug. 15, 2024

(54) BATTERY, METHOD FOR MANUFACTURING BATTERY, AND CIRCUIT BOARD

(71) Applicant: Panasonic Intellectual Property Management Co., Ltd., Osaka (JP)

(72) Inventors: KAZUYOSHI HONDA, Osaka (JP); AKIRA KAWASE, Osaka (JP); KAZUHIRO MORIOKA, Osaka (JP); EIICHI KOGA, Hokkaido (JP); KOICHI HIRANO, Osaka (JP)

(21) Appl. No.: 18/641,248

(22) Filed: Apr. 19, 2024

Related U.S. Application Data
(63) Continuation of application No. PCT/JP2022/030059, filed on Aug. 5, 2022.

(30) Foreign Application Priority Data
Nov. 16, 2021 (JP) 2021-186417

(51) Int. Cl. H01M 10/04; H01M 10/0585; H01M 50/209; H01M 50/51; H01M 50/519

(52) U.S. Cl. CPC H01M 10/0436; H01M 10/0585; H01M 50/209; H01M 50/51; H01M 50/519

(57) ABSTRACT

A battery includes: a power generation element including at least one battery cell each having a laminated structure of a positive electrode layer, a negative electrode layer, and a solid electrolyte layer located between the positive electrode layer and the negative electrode layer, in which the at least one battery cell is each provided with a through hole penetrating in a direction of lamination, a sectional area of the through hole in the positive electrode layer in a direction perpendicular to the direction of lamination is larger than a sectional area of the through hole in the negative electrode layer in the direction perpendicular to the direction of lamination, and an inner wall of the through hole is inclined with respect to the direction of lamination.

### BACKGROUND

### 1. Technical Field

The present disclosure relates to a battery, a method for manufacturing a battery, and a circuit board.

### 2. Description of the Related Art

Japanese Unexamined Patent Application Publication No. 2005-235738 discloses a concept of forming through holes in a battery and providing a wiring pattern by using the through holes.

Japanese Unexamined Patent Application Publication No. 2007-207510 discloses a concept of forming through holes in a battery and fastening the battery by using the through holes.

### SUMMARY

The related art faces a demand for improving reliability while enhancing usability when a battery is used by being connected to a circuit. In a case of mounting a battery on a board, for example, there is a demand for improving reliability while enhancing usability by increasing more variations to mount the battery and other devices.

Meanwhile, an increase in capacity density is desirable in a battery connected to a circuit. In the case of mounting a battery on a board, for example, it is an important point to reduce a mounting area of the battery in order to increase the capacity density. The reduction in mounting area of the battery is equivalent to reduction in projected area of a power generation element of the battery in plan view of the board, and of each of terminals or the like for extracting an electric current from the power generation element of the battery, for example.

One non-limiting and exemplary embodiment provides a battery, a method for manufacturing a battery, and a circuit board, which can achieve a high capacity density and high usability at the same time.

In one general aspect, the techniques disclosed here feature a battery including: a power generation element including at least one battery cell each having a laminated structure of a positive electrode layer, a negative electrode layer, and a solid electrolyte layer located between the positive electrode layer and the negative electrode layer, in which the at least one battery cell is each provided with a through hole penetrating in a direction of lamination, a sectional area of the through hole in the positive electrode layer in a direction perpendicular to the direction of lamination is larger than a sectional area of the through hole in the negative electrode layer in the direction perpendicular to the direction of lamination, and an inner wall of the through hole is inclined with respect to the direction of lamination.

According to the battery and the like of the present disclosure, a high capacity density and high usability can be achieved at the same time.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a battery according to Embodiment 1;

FIG. 2 is a top plan view of the battery according to the Embodiment 1;

FIG. 3A is a sectional view of an example of a battery cell included in a power generation element according to the Embodiment 1;

FIG. 3B is a sectional view of another example of the battery cell included in the power generation element according to the Embodiment 1;

FIG. 3C is a sectional view of still another example of the battery cell included in the power generation element according to the Embodiment 1;

FIG. 4 is a sectional view of the power generation element according to the Embodiment 1;

FIG. 5 is a sectional view illustrating a usage example of the battery according to the Embodiment 1;

FIG. 6 is a sectional view of a battery according to Embodiment 2;

FIG. 7 is a sectional view of a battery according to Embodiment 3;

FIG. 8 is a sectional view of a battery according to Embodiment 4;

FIG. 9 is a sectional view of a battery according to Embodiment 5;

FIG. 10 is a sectional view of a battery according to Embodiment 6;

FIG. 11 is a sectional view of a battery according to Embodiment 7;

FIG. 12 is a top plan view of the battery according to the Embodiment 7;

FIG. 13 is a sectional view of a battery according to another example of Embodiment 7;

FIG. 14 is a sectional view of a circuit board according to Embodiment 8;

FIG. 15 is a flowchart illustrating a first example of a method for manufacturing a battery according to an embodiment;

FIG. 16 is a flowchart illustrating a second example of the method for manufacturing a battery according to the embodiment;

FIG. 17 is a flowchart illustrating a third example of the method for manufacturing a battery according to the embodiment; and

FIG. 18 is a flowchart illustrating a fourth example of the method for manufacturing a battery according to the embodiment.

### DETAILED DESCRIPTIONS

### Summary of Present Disclosure

For example, a battery according to an aspect of the present disclosure includes: a power generation element including at least one battery cell each having a laminated structure of a positive electrode layer, a negative electrode layer, and a solid electrolyte layer located between the positive electrode layer and the negative electrode layer, in which the at least one battery cell is each provided with a through hole penetrating in a direction of lamination, a sectional area of the through hole in the positive electrode layer in a direction perpendicular to the direction of lamination is larger than a sectional area of the through hole in the negative electrode layer in the direction perpendicular to the direction of lamination, and an inner wall of the through hole is inclined with respect to the direction of lamination.

Thus, it is possible to realize a battery that achieves both a high capacity density and high reliability.

To be more precise, it is possible to reduce the area of the positive electrode layer as compared to that of the negative electrode layer by using the through hole having the sectional area in the positive electrode layer in the direction perpendicular to the direction of lamination being larger than the sectional area in the negative electrode layer in the direction perpendicular to the direction of lamination. Accordingly, it is possible to suppress precipitation and the like of a metal originating from metallic ions that fail to be captured in the negative electrode layer, thereby enhancing reliability and safety of the battery.

Moreover, the through hole can realize a difference in area between the positive electrode layer and the negative electrode layer. Accordingly, it is not necessary to form the battery cell by proving a difference in area between the positive electrode layer and the negative electrode layer in advance. For this reason, it is possible to form the battery cell while accurately determining the respective areas of the positive electrode layer, the negative electrode layer, and the solid electrolyte layer while avoiding a gradual increase and a gradual decrease in film thickness and the like at starting and terminating ends when coating each layer. In this way, it is possible to make maximum use of the capacity of the battery cell. Moreover, since the conductive member for extracting the electric current from the power generation element and the like can be passed through the through hole, it is possible to reduce the area in plan view inclusive of the members for extracting the electric current and the like. Thus, the capacity density of the battery can be increased.

For example, in the power generation element, the through hole of the at least one battery cell may be open on a first principal surface and a second principal surface on an opposite side to the first principal surface of the power generation element, respectively, and the battery further may include a conductive member being electrically connected to the second principal surface of the power generation element and extending from an opening position of the through hole at the second principal surface to an opening position of the through hole at the first principal surface while passing through the through hole.

As such, the conductive member can guide a potential at the second principal surface of the power generation element to the first principal surface side. In other words, both of the electric currents on the positive electrode and on the negative electrode of the power generation element can be extracted on the first principal surface side. Accordingly, it is possible to assemble compact mounting of the battery. For example, a pattern of connection terminals to be formed on a board can be reduced in size. Thus, it is possible to realize the battery that is excellent in mountability. Moreover, the conductive member passes through the power generation element. Therefore, it is not necessary to form a structure required for extracting the electric current on a side surface side of the power generation element. Accordingly, the battery can be downsized so that the capacity density of the battery can be increased. It is possible to reduce the mounting area when the battery is mounted on the board, for example.

For example, the battery may further include: an insulating member located between the conductive member and the inner wall of the through hole.

As such, insulation between the conductive member and the battery cell is secured inside the through hole, so that reliability of the battery can be enhanced.

For example, the insulating member may cover the inner wall of the through hole.

As such, it is possible to suppress collapse of materials of the respective layers of the battery cell on the inner wall of the through hole and to suppress a short circuit between the positive electrode layer and the negative electrode layer.

For example, the through hole may have a truncated cone shape.

As such, no corners are formed on the inner wall of the through hole, so that electric field concentration can be suppressed inside the through hole.

For example, the at least one battery cell may include a plurality of battery cells, and the plurality of battery cells may be laminated. For example, at least a portion of the plurality of battery cells may be laminated while being electrically connected in parallel. For example, the plurality of battery cells may be laminated while being electrically connected in series.

As such, it is possible to realize the high-voltage battery without changing the area in plan view when the battery cells are laminated while being connected in series. On the other hand, it is possible to realize the large-capacity battery without changing the area in plan view when the battery cells are laminated while being connected in parallel.

For example, volumes of the respective through holes of the plurality of battery cells may be equal.

As such, volumes of the respective battery cells are likely to conform with one another, so that a variation in capacity among the battery cells can be suppressed.

For example, the inner walls of the respective through holes of the plurality of battery cells may form a continuous surface inclined with respect to the direction of lamination.

As such, a portion that is prone to breakage is hardly formed on the inner wall and it is less likely that the materials of the battery cell collapse on the inner wall.

For example, the respective through holes of the plurality of battery cells may be concatenated.

As such, it is easier to form other members and the like in the through hole.

For example, in the power generation element, a portion of the plurality of battery cells may constitute a first cell laminated body by being laminated in such a way as to concatenate the through holes, another portion of the plurality of battery cells may constitute a second cell laminated body by being laminated in such a way as to concatenate the through holes, and a position of the through holes in the first cell laminated body may be different from a position of the through holes in the second cell laminated body when viewed in the direction of lamination.

Accordingly, even when the number of the laminated battery cells is increased and a problem is likely to occur as a consequence of forming the through holes at the same position of all of the battery cells, the through holes can instead be formed while changing the positions thereof. Thus, it is possible to avoid a situation where it is difficult to form the insulating member and the like inside the through holes due to the increase in the number of the battery cells, for example.

For example, a method for manufacturing a battery according to another aspect of the present disclosure includes: forming a laminated body by laminating a plurality of battery cells; forming a through hole in each of the plurality of battery cells in such a way as to penetrate in a direction of lamination; forming a conductive member that passes through the through hole formed in each of the plurality of battery cells and penetrates each of the plurality of battery cells; and forming an insulating member to be disposed between an inner wall of the through hole formed in each of the plurality of battery cells and the conductive member, in which the through hole is formed in the forming a through hole such that a sectional area of the through hole in a positive electrode layer in a direction perpendicular to the direction of lamination is larger than a sectional area of the through hole in a negative electrode layer in the direction perpendicular to the direction of lamination.

In this way, it is possible to manufacture the battery by laminating the battery cells, which achieves a high capacity density and high usability as mentioned above.

In this way, it is also possible to form the conductive member that induces a potential at one principal surface of the above-mentioned laminated body to another principal surface side thereof, and to form the battery provided with the insulating member that insulates the conductive member from the battery cell inside the through hole.

For example, the forming a through hole may be carried out after the forming a laminated body.

In this way, the laminated battery cells can be provided with the through holes in a lump, respectively. Thus, productivity of the battery is improved.

For example, in the forming a laminated body, the plurality of battery cells may be laminated in such a way as to concatenate the respective through holes of the plurality of battery cells after the forming a through hole; and each of the forming an insulating member and the forming a conductive member may be carried out after the forming a laminated body.

In this way, it is possible to provide each battery cell with the through hole. Accordingly, freedom of a shape of each through hole thus formed is increased. Meanwhile, the conductive member and the insulating member can be formed in a lump in each of the through holes of the laminated battery cells. Thus, productivity of the battery is improved.

For example, each of the forming a through hole, the forming an insulating member, and the forming a conductive member may be carried out before the forming a laminated body.

In this way, it is possible to form the insulating member and the conductive member in each of the respective through holes of the battery cells. Accordingly, the insulating member and the conductive member can be formed easily and accurately.

For example, each of the forming a through hole and the forming an insulating member may be carried out before the forming a laminated body, and the forming a conductive member may be carried out after the forming a laminated body.

In this way, it is possible to form the insulating member easily and accurately, which is required to be formed accurately in order to improve reliability of the battery. Moreover, since the conductive member can be formed in a lump in the through holes of the laminated battery cells, productivity of the battery is improved.

A circuit board according to still another aspect of the present disclosure includes: a power generation element including at least one battery cell each having a laminated structure of a positive electrode layer, a negative electrode layer, and a solid electrolyte layer located between the positive electrode layer and the negative electrode layer; a conductive member; and a circuit pattern layer being laminated on the power generation element and including circuit wiring, in which the at least one battery cell is each provided with a through hole penetrating in a direction of lamination, a sectional area of the through hole in the positive electrode layer in a direction perpendicular to the direction of lamination is larger than a sectional area of the through hole in the negative electrode layer in the direction perpendicular to the direction of lamination, in the power generation element, the through hole of the at least one battery cell is open on a first principal surface and a second principal surface on an opposite side to the first principal surface of the power generation element, respectively, the conductive member is electrically connected to the second principal surface of the power generation element, extends from an opening position of the through hole at the second principal surface to an opening position of the through hole at the first principal surface while passing through the through hole, and is electrically connected to a portion of the circuit wiring, and the circuit pattern layer is located on the first principal surface side of the power generation element.

In this way, the circuit board including the battery that achieves the high capacity density and high usability as mentioned above, and the circuit pattern layer connected to the battery is realized. Meanwhile, since a wiring board and the battery are integrated together, it is possible to achieve downsizing and thin profiling of electronic equipment. In the meantime, electric power can be directly supplied from the power generation element to a required location on the circuit wiring. Thus, it is possible to reduce extension of wiring and to suppress radiation noise from the wiring.

Embodiments will be specifically described below with reference to the drawings.

Note that each embodiment described below represents a comprehensive or specific example. Numerical values, shapes, materials, constituents, layout positions and modes of connection of the constituents, steps, the order of the steps, and the like depicted in the following embodiments are examples and are not intended to restrict the present disclosure. Meanwhile, of the constituents in the following embodiments, a constituent not defined in an independent claim will be described as an optional constituent.

In the meantime, the respective drawings are schematic diagrams and are not always illustrated precisely. Accordingly, scales and other factors do not always coincide with one another in the respective drawings, for example. Moreover, in the respective drawings, the structures which are substantially the same are denoted by the same reference signs and overlapping explanations thereof may be omitted or simplified.

Meanwhile, in the present specification, terms that represent relations between elements such as parallelism and orthogonality, terms that represent shapes of the elements such as a rectangle and a rectangular parallelepiped, and numerical ranges are not expressions that only represent precise meanings but are rather expressions that encompass substantially equivalent ranges with allowances of several percent, for example.

In the meantime, in the present specification and the drawings, x axis, y axis, and z axis represent three axes of a three-dimensional orthogonal coordinate system. In a case where a shape in plan view of a power generation element of a battery is a rectangle, the x axis and the y axis coincide with directions parallel to a first side of the rectangle and to a second side being orthogonal to the first side, respectively. The z axis coincides with a direction of lamination of battery cells included in the power generation element and of respective layers of each battery cell.

Meanwhile, in the present specification, a “direction of lamination” coincides with a direction of a normal line to principal surfaces of current collectors and active material layers. Moreover, in the present specification, a “plan view” means a view in a direction perpendicular to a principal surface of the power generation element unless otherwise specifically stated such as a case where the term is used alone. Here, in a case of description of a “plan view of a certain surface” such as a “plan view of a first side surface”, the term means a view from the front of the “certain surface”.

In the meantime, in the present specification, terms “above” and “below” do not represent an upward direction (vertically upward) and a downward direction (vertically downward) in light of absolute spatial recognition, but are used as terms to be defined depending on a relative positional relationship based on the order of lamination in a laminated structure. Moreover, the terms “above” and “below” are used not only in a case where two constituents are disposed with an interval therebetween and another constituent is present between these two constituents, but also in a case where two constituents are disposed close to each other and the two constituents are in contact with each other. In the following description, a negative side of the z axis will be referred to as “below” or a “lower side” while a positive side of the z axis will be referred to as “above” or an “upper side”.

Meanwhile, in the present specification, an expression “to cover A” means to cover at least a portion of “A”. Specifically, the expression “to cover A” is the expression encompassing not only a case of “covering all of A” but also a case of “covering only a portion of A”. Here, “A” is a side surface, a principal surface, and the like of a layer or a certain member such as a terminal.

In the meantime, in the present specification, ordinal numbers such as “first” and “second” are not intended to represent the number or the order of the constituents but are used for the purpose of distinguishing the constituents while avoiding confusion of the constituents of the same type unless otherwise specifically stated.

### Embodiment 1

A configuration of a battery according to Embodiment 1 will be described below.

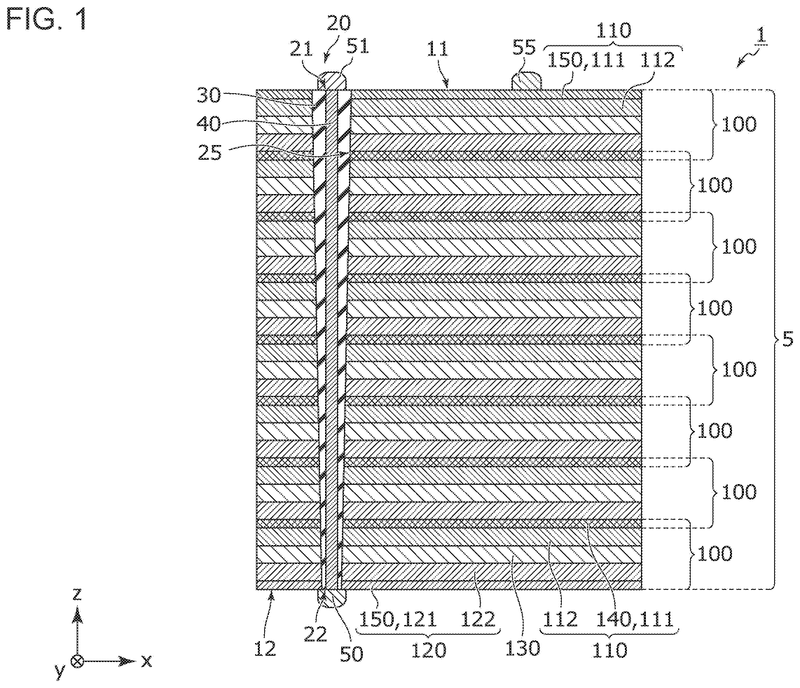

FIG. 1 is a sectional view of a battery 1 according to the present embodiment. As illustrated in FIG. 1, the battery 1 includes a power generation element 5, an insulating member 30, a conductive member 40, a connecting member 50, a current collecting terminal 51, a current collecting terminal 55. The battery 1 is an all-solid-state battery, for example.

### 1. Power Generation Element

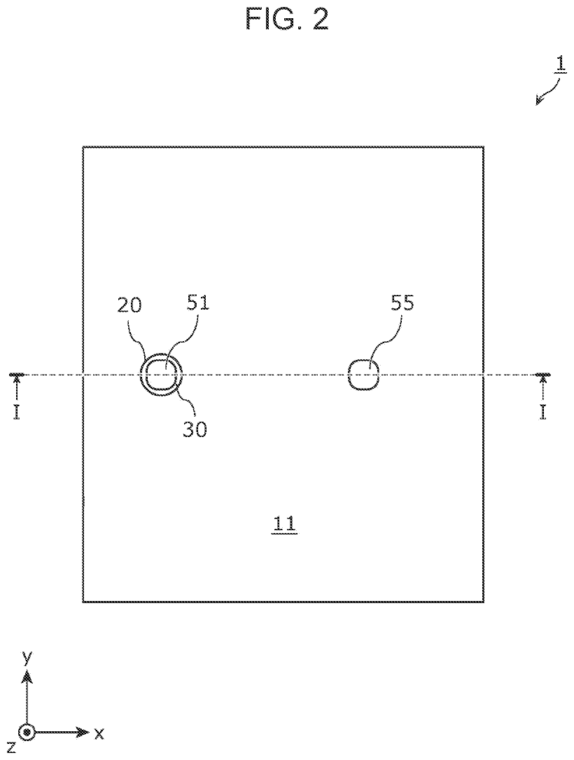

First, a specific configuration of the power generation element 5 will be described with reference to FIGS. 1 and 2. FIG. 2 is a top plan view of the battery 1 according to the present embodiment. Here, FIG. 1 illustrates a section taken along the I-I line in FIG. 2.

As illustrated in FIG. 2, a shape in plan view of the power generation element 5 is a rectangle, for example. In other words, the shape of the power generation element 5 is a flat rectangular parallelepiped. Here, flatness means that a thickness (namely, a length in z-axis direction) is shorter than respective sides (namely, respective lengths in x-axis direction and y-axis direction) or a maximum width of a principal surface. The shape in plan view of the power generation element 5 may be any of other polygons including a square, a hexagon, and an octagon, or may be any of a circle, an ellipse, and the like. It is to be noted that a thickness of each of layers is illustrated in an exaggerated manner in the sectional views such as FIG. 1 in order to clarify a layered structure of the power generation element 5.

As illustrated in FIGS. 1 and 2, the power generation element 5 includes a principal surface 11 and a principal surface 12 as two principal surfaces thereof. In the present embodiment, each of the principal surface 11 and the principal surface 12 is a flat surface.

The principal surface 11 is an example of a first principal surface. The principal surface 12 is an example of a second principal surface. The principal surface 11 and the principal surface 12 are back to back to each other and are parallel to each other. The principal surface 11 is the uppermost surface of the power generation element 5. The principal surface 12 is a surface on an opposite side to the principal surface 11 and is the lowermost surface of the power generation element 5. Each of the principal surface 11 and the principal surface 12 has a larger area than that of a side surface of the power generation element 5, for example.

Side surfaces of the power generation element 5 include two sets of two side surfaces being back to back to each other and parallel to each other. Each side surface of the power generation element 5 is a flat surface, for example. Each side surface of the power generation element 5 is a cut surface formed by cutting a laminated body of battery cells 100 in a lump, for example. The battery cells 100 having the same size can be formed by aligning a cutting direction with a direction of lamination.

As illustrated in FIG. 1, the power generation element 5 includes the battery cells 100. Each battery cell 100 is a battery of a minimum structure and is also referred to as a unit cell. The battery cells 100 are laminated while being electrically connected in series. Thus, it is possible to realize the high-voltage battery 1 without increasing the area in plan view. In the present embodiment, all of the battery cells 100 included in the power generation element 5 are electrically connected in series. The battery 1 is a laminated battery formed by integrating the battery cells 100 by means of adhesion, bonding, or the like. Although the number of the battery cells 100 included in the power generation element 5 is eight cells in the example illustrated in FIG. 1, the number of the battery cells is not limited to the foregoing. For example, the number of the battery cells 100 included in the power generation element 5 may be even cells such as two cells and four cells, or odd cells such as three cells and five cells.

Each of the battery cells 100 is provided with a through hole 20 that penetrates each battery cell 100 in the direction of lamination. The respective through holes 20 in the battery cells 100 are formed in a lump by drilling a hole that penetrates the power generation element 5 in the direction of lamination, for example.

Each of the battery cells 100 includes a positive electrode layer 110, a negative electrode layer 120, and a solid electrolyte layer 130. The positive electrode layer 110 includes a positive electrode current collector 111 and a positive electrode active material layer 112. The negative electrode layer 120 includes a negative electrode current collector 121 and a negative electrode active material layer 122. In each of the battery cells 100, the positive electrode current collector 111, the positive electrode active material layer 112, the solid electrolyte layer 130, the negative electrode active material layer 122, and the negative electrode current collector 121 are laminated in this order along the z axis. In each battery cell 100, the positive electrode current collector 111, the positive electrode active material layer 112, the solid electrolyte layer 130, the negative electrode active material layer 122, and the negative electrode current collector 121 extend in directions perpendicular to the z-axis direction (namely, in the x-axis direction and the y-axis direction), respectively.

Configurations of the respective battery cells 100 are substantially the same as one another, for example. In the power generation element 5, the battery cells 100 are laminated in an arrangement along the z axis such that the orders of arrangement of the respective layers constituting the battery cells 100 are the same. Accordingly, the battery cells 100 are laminated while being electrically connected in series. The battery cells 100 have the same size as one another, for example. This makes it easier to conform states of operation among the battery cells 100 so that the battery 1 achieving both a high capacity density and high reliability can be realized.

In the present embodiment, the principal surface 11 constitutes a portion of the positive electrode layer 110 of the battery cell 100 located uppermost. To be more precise, the principal surface 11 is a principal surface on the upper side of the positive electrode layer 110 of the battery cell 100 located uppermost.

Meanwhile, the principal surface 12 constitutes a portion of the negative electrode layer 120 of the battery cell 100 located lowermost. To be more precise, the principal surface 12 is a principal surface on the lower side of the negative electrode layer 120 of the battery cell 100 located lowermost.

In the present embodiment, a current collector is shared by two battery cells 100 located adjacent to each other in the direction of lamination among the multiple battery cells 100. Specifically, the positive electrode current collector 111 of one of the two battery cells 100 and the negative electrode current collector 121 of the other one of the two battery cells 100 form one intermediate layer current collector 140.

To be more precise, the positive electrode active material layer 112 is laminated on a lower surface of the intermediate layer current collector 140. The negative electrode active material layer 122 is laminated on an upper surface of the intermediate layer current collector 140. The intermediate layer current collector 140 is also referred to as a bipolar current collector.

End portion layer current collectors 150 illustrated in FIG. 1 are located on both ends in the direction of lamination of the power generation element 5. The end portion layer current collector 150 located on an upper end being one end in the direction of lamination is the positive electrode current collector 111. The positive electrode active material layer 112 is disposed at a lower surface of the positive electrode current collector 111. The end portion layer current collector 150 located on a lower end being another end in the direction of lamination is the negative electrode current collector 121. The negative electrode active material layer 122 is disposed at an upper surface of the negative electrode current collector 121.

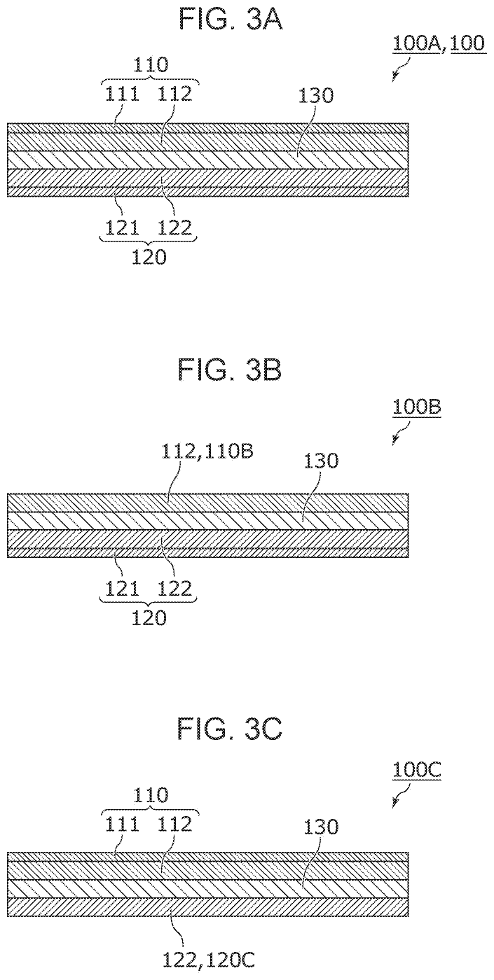

A description will be given below of the respective layers of the battery cell 100 with reference to FIG. 3A. FIG. 3A is a sectional view of the battery cell 100 included in the power generation element 5 according to the present embodiment.

Each of the positive electrode current collector 111 and the negative electrode current collector 121 illustrated in FIG. 3A is either the intermediate layer current collector 140 or the end portion layer current collector 150 illustrated in FIG. 1. Each of the positive electrode current collector 111 and the negative electrode current collector 121 is a conductive member in any of a foil form, a plate form, and a mesh form. Each of the positive electrode current collector 111 and the negative electrode current collector 121 may be a conductive thin film, for example. Examples of a material usable for constituting the positive electrode current collector 111 and the negative electrode current collector 121 include metals such as stainless steel (SUS), aluminum (Al), copper (Cu), and nickel (Ni). The positive electrode current collector 111 and the negative electrode current collector 121 may be formed by using different materials from each other.

A thickness of each of the positive electrode current collector 111 and the negative electrode current collector 121 is greater than or equal to 5 μm and less than or equal to 100 μm, for example. However, the thickness is not limited to this range. The positive electrode active material layer 112 is in contact with the principal surface of the positive electrode current collector 111. Here, the positive electrode current collector 111 may include a current collector layer which is a layer being provided at a portion in contact with the positive electrode active material layer 112 and containing a conductive material. The negative electrode active material layer 122 is in contact with the principal surface of the negative electrode current collector 121. Here, the negative electrode current collector 121 may include a current collector layer which is a layer being provided at a portion in contact with the negative electrode active material layer 122 and containing a conductive material.

In the meantime, the intermediate layer current collector 140 and the end portion layer current collector 150 may employ current collectors having the same thickness and being made of the same material or employ current collectors having different thicknesses and being made of different materials from each other depending on strengths, bonding performances, properties of the active material layers in contact therewith, and so forth.

The positive electrode active material layer 112 is disposed at the principal surface on the negative electrode layer 120 side of the positive electrode current collector 111. The positive electrode active material layer 112 is a layer including a positive electrode material such as an active material. The positive electrode active material layer 112 contains a positive electrode active material, for example.

A positive electrode active material such as lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO) can be used as the positive electrode active material contained in the positive electrode active material layer 112, for example. Various materials that can extract and insert ions such as Li and Mg can be used as the material of the positive electrode active material.

Meanwhile, a solid electrolyte such as an inorganic solid electrolyte may be used as a material contained in the positive electrode active material layer 112, for example. A sulfide solid electrolyte, an oxide solid electrode, and the like can be used as the inorganic solid electrolyte. A mixture of Li₂S and P₂S ₅ can be used as the sulfide solid electrolyte, for example. A surface of the positive electrode active material may be coated with a solid electrolyte. In the meantime, a conducting agent such as acetylene black or a binder such as polyvinylidene fluoride may be used as the material contained in the positive electrode active material layer 112.

The positive electrode active material layer 112 is fabricated by applying a coating material in the form of a paste, which is prepared by kneading the materials contained in the positive electrode active material layer 112 together with a solvent, onto the principal surface of the positive electrode current collector 111 and drying the coating material. In order to increase a density of the positive electrode active material layer 112, the positive electrode layer 110 including the positive electrode active material layer 112 and the positive electrode current collector 111 (also referred to as an electrode plate) may be pressed after a drying process. A thickness of the positive electrode active material layer 112 is greater than or equal to 5 μm and less than or equal to 300 μm, for example. However, the thickness is not limited to this range.

The negative electrode active material layer 122 is disposed on the principal surface on the positive electrode layer 110 side of the negative electrode current collector 121. The negative electrode active material layer 122 is disposed opposite to the positive electrode active material layer 112. The negative electrode active material layer 122 is a layer including a negative electrode material such as an active material. The negative electrode material is a material constituting a counter electrode to the positive electrode material. The negative electrode active material layer 122 contains a negative electrode active material, for example.

A negative electrode active material such as graphite and metallic lithium can be used as the negative electrode active material to be contained in the negative electrode active material layer 122, for example. Various materials that can extract and insert ions as typified by lithium (Li) and magnesium (Mg) can be used as the material of the negative electrode active material.

Meanwhile, a solid electrolyte such as an inorganic solid electrolyte may be used as a material contained in the negative electrode active material layer 122, for example. A sulfide solid electrolyte, an oxide solid electrode, and the like can be used as the inorganic solid electrolyte, for example. A mixture of lithium sulfide (Li₂S) and phosphorus pentasulfide (P₂S₅) can be used as the sulfide solid electrolyte, for example. In the meantime, a conducting agent such as acetylene black or a binder such as polyvinylidene fluoride may be used as the material contained in the negative electrode active material layer 122.

The negative electrode active material layer 122 is fabricated by applying a coating material in the form of a paste, which is prepared by kneading the materials contained in the negative electrode active material layer 122 together with a solvent, onto the principal surface of the negative electrode current collector 121 and drying the coating material. In order to increase a density of the negative electrode active material layer 122, the negative electrode layer 120 including the negative electrode active material layer 122 and the negative electrode current collector 121 (also referred to as a negative electrode plate) may be pressed after a drying process. A thickness of the negative electrode active material layer 122 is greater than or equal to 5 μm and less than or equal to 300 μm, for example. However, the thickness is not limited to this range.

The solid electrolyte layer 130 is disposed between the positive electrode active material layer 112 and the negative electrode active material layer 122. The solid electrolyte layer 130 is in contact with the positive electrode active material layer 112 and with the negative electrode active material layer 122, respectively. The solid electrolyte layer 130 is a layer including an electrolyte material. Publicly known electrolytes designed for batteries can be used as such an electrolyte material. A thickness of the solid electrolyte layer 130 may be greater than or equal to 5 μm and less than or equal to 300 μm, or may be greater than or equal to 5 μm and less than or equal to 100 μm.

The solid electrolyte layer 130 contains a solid electrolyte. The solid electrolyte has lithium-ion conductivity, for example. A solid electrolyte such as an inorganic solid electrolyte can be used as the solid electrode, for example. A sulfide solid electrolyte, an oxide solid electrode, and the like can be used as the inorganic solid electrolyte. A mixture of Li₂S and P₂S₅ can be used as the sulfide solid electrolyte, for example. Here, the solid electrolyte layer 130 may contain a binder such as polyvinylidene fluoride in addition to the electrolyte material.

In the present embodiment, the positive electrode active material layer 112, the negative electrode active material layer 122, and the solid electrolyte layer 130 are maintained in a state of parallel flat plates. In this way, it is possible to suppress the occurrence of cracks or collapse due to flexure. Here, the positive electrode active material layer 112, the negative electrode active material layer 122, and the solid electrolyte layer 130 may be integrated and gently curved together.

Meanwhile, in the present embodiment, an end surface of the positive electrode current collector 111 and an end surface of the negative electrode current collector 121 coincide with each other when viewed in the z-axis direction.

To be more precise, in the battery cell 100, respective shapes and sizes of the positive electrode current collector 111, the positive electrode active material layer 112, the solid electrolyte layer 130, the negative electrode active material layer 122, and the negative electrode current collector 121 are the same and contours of the respective layers coincide with one another. In other words, the shape of the battery cell 100 is a flat plate shape in the form of a flat rectangular parallelepiped.

As described above, in the power generation element 5 according to the present embodiment, each intermediate layer current collector 140 is shared by the battery cells 100 as illustrated in FIG. 1. The above-mentioned power generation element 5 is formed by laminating not only the battery cells 100 illustrated in FIG. 3A but also battery cells 100B and 100C illustrated in FIGS. 3B and 3C in combination. Note that the battery cell 100 illustrated in FIG. 3A will be explained herein as a battery cell 100A.

The battery cell 100B illustrated in FIG. 3B has a configuration to exclude the positive electrode current collector 111 from the battery cell 100A illustrated in FIG. 3A. That is to say, a positive electrode layer 110B of the battery cell 100B consists of the positive electrode active material layer 112.

The battery cell 100C illustrated in FIG. 3C has a configuration to exclude the negative electrode current collector 121 from the battery cell 100A illustrated in FIG. 3A. That is to say, a negative electrode layer 120C of the battery cell 100C consists of the negative electrode active material layer 122.

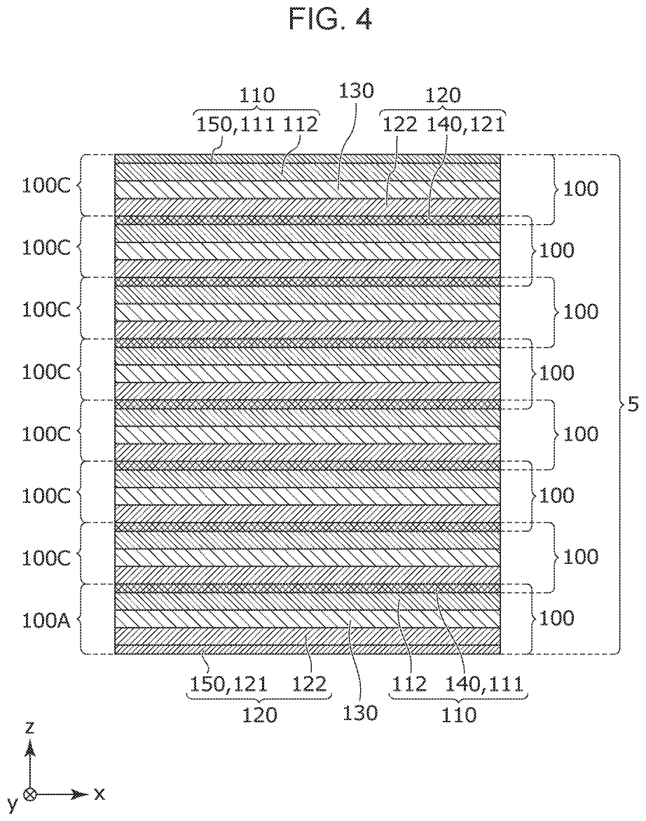

FIG. 4 is a sectional view illustrating the power generation element 5 according to the present embodiment. FIG. 4 is a view extracting only the power generation element 5 in FIG. 1 and illustrating a state before formation of the through hole 20 in a plurality of battery cells 100. As illustrated in FIG. 4, the battery cell 100A is disposed at the lowermost layer and the battery cells 100C in the same orientation are sequentially laminated upward. The power generation element 5 is formed in this way.

Note that the method of forming the power generation element 5 is not limited to this method. For example, the battery cells 100B in the same orientation may be sequentially laminated and then the battery cell 100A may be disposed at the uppermost layer. On the other hand, the battery cell 100A may be disposed at a position different from both the uppermost layer and the lowermost layer, for example. In the meantime, the battery cells 100A may be used instead. Otherwise, a unit of two battery cells 100 sharing a current collector may be formed by subjecting a single current collector to double-sided coating, and the units thus formed may be laminated.

As described above, in the power generation element 5 according to the present embodiment, all of the battery cells 100 are connected in series and no batteries connected in parallel are included therein. Thus, the high-voltage battery 1 can be realized.

2. Through holes

Next, the through hole 20 will be described with reference to FIGS. 1 and 2 again.

The through hole 20 is provided to each of the battery cells 100. In each of the battery cells 100, the through hole 20 penetrates from one principal surface to another principal surface. The through hole 20 originates from the one principal surface of the battery cell 100, passes through the positive electrode layer 110, the solid electrolyte layer 130, and negative electrode layer 120, and reaches the other principal surface thereof.

Regarding each of the through holes 20 in the battery cells 100, a sectional area of the through hole 20 in the positive electrode layer 110 in a direction perpendicular to the direction of lamination is larger than a sectional area of the through hole 20 in the negative electrode layer 120 in the direction perpendicular to the direction of lamination. The direction perpendicular to the direction of lamination is equivalent to a direction of extension of each layer. As a consequence, the sectional area of the through hole 20 becomes larger at the position of the principal surface on the negative electrode active material layer 122 side of the positive electrode active material layer 112, and the area of the relevant principal surface of the positive electrode active material layer 112 becomes smaller accordingly. For this reason, it is possible to suppress precipitation and the like of a metal (so-called a dendrite) originating from metallic ions that fail to be captured in the negative electrode layer 120, thereby enhancing reliability and safety of the battery 1.

Regarding each of the through holes 20 in the battery cells 100, a width of the through hole 20 in the positive electrode layer 110 is larger than a width of the through hole 20 in the negative electrode layer 120 in sectional view.

The respective through holes 20 in the battery cells 100 are concatenated. Accordingly, the respective through holes 20 of the battery cells 100 collectively constitute a single through hole that penetrates the power generation element 5 in the direction of lamination. This configuration makes it easier to form a conductive member 40 or the like that extends through the through holes 20.

In the power generation element 5, the through hole 20 of the battery cell 100 located uppermost is open on the principal surface 11. That is to say, an opening position 21 of the through hole 20 of the battery cell 100 located uppermost is located at the principal surface 11. Meanwhile, in the power generation element 5, the through hole 20 of the battery cell 100 located lowermost is open on the principal surface 12. That is to say, an opening position 22 of the through hole 20 of the battery cell 100 located lowermost is located at the principal surface 12.

In the present embodiment, in each of the battery cells 100, the positive electrode layer 110 is disposed on the principal surface 11 side while the negative electrode layer 120 is disposed on the principal surface 12 side. The through hole 20 has such a shape that its sectional area on the principal surface 12 side in the direction of lamination is smaller. Accordingly, an opening area of the through hole 20 on the principal surface 11 is larger than an opening area of the through hole 20 on the principal surface 12. As described later, the current collecting terminal 51 is located on an inner side of the through hole 20 in plan view of the principal surface 11. Since the opening area of the through hole 20 is larger on the principal surface 11, it is easier to form the current collecting terminal 51 to be provided on the principal surface 11 side.

An inner wall 25 of each of the through holes 20 of the battery cells 100 is inclined with respect to the direction of lamination. That is to say, each of the through holes 20 of the battery cells 100 includes the inner wall 25 of a tapered shape. Accordingly, it is possible to differentiate between the sectional areas of the through hole 20 in the positive electrode layer 110 and the negative electrode layer 120 easily. The inner wall 25 is an inner side surface of the battery cell 100 constituting the through hole 20. In the present embodiment, the entire surface of the inner wall 25 is inclined with respect to the direction of lamination. Note that there may be a portion on the inner wall 25 which is not inclined with respect to the direction of lamination. The inner wall 25 is formed from inner side surfaces of the positive electrode layer 110, the solid electrolyte layer 130, and the negative electrode layer 120, for example.

Meanwhile, each of the through holes 20 of the battery cells 100 has a truncated cone shape, for example. Accordingly, no corners are formed on the inner wall 25 of the through hole 20, so that electric field concentration can be suppressed inside the through hole 20. Moreover, the through hole 20 can be formed easily with a drill having a tapered angle, for example. Note that the shape of the through hole 20 is not limited to the truncated cone shape but may be any other shapes including a truncated polygonal pyramid shape such as a truncated quadrangular pyramid shape and a truncated hexagonal pyramid shape, and so forth.

The inner walls 25 of the respective through holes 20 of the battery cells 100 form one continuous surface which is inclined with respect to the direction of lamination. Accordingly, the respective through holes 20 of the battery cells 100 are concatenated in such a way as to penetrate the power generation element 5 in the direction of lamination, thereby forming a single elongate through hole of a truncated cone shape. Since the inner walls 25 of the respective through holes 20 of the battery cells 100 are concatenated as described above, a portion that is prone to breakage is hardly formed on the inner walls 25 and it is less likely that the materials of the battery cell 100 collapse on the inner walls 25. Meanwhile, materials for forming the insulating member 30 and the conductive member 40 are easily inserted into the through holes 20. Here, a direction of concatenation of the respective through holes 20 of the battery cells 100 may be inclined with respect to the direction of lamination.

### 3. Insulating Member

Next, the insulating member 30 will be described.

The insulating member 30 is disposed inside the through holes 20. The insulating member 30 is located between the conductive member 40 and the inner walls 25 of the through holes 20. The insulating member 30 can secure insulation between the conductive member 40 and the inner side surfaces of the battery cells 100 which are the inner walls 25 of the through holes 20.

The insulating member 30 is disposed along the inner walls 25 of the through holes 20. The insulating member 30 covers the inner walls 25 of the respective through holes 20 of the battery cells 100 in a lump and is in contact with the inner walls 25 of the through holes 20 of the battery cells 100. This makes it possible to suppress collapse of the materials of the respective layers of the battery cells 100 on the inner walls 25 of the through holes 20 and to suppress a short circuit between the positive electrode layer 110 and the negative electrode layer 120. The insulating member 30 covers the entire inner walls 25 of the respective through holes 20 of the battery cells 100, for example. A clearance may be provided at a certain part between the insulating member 30 and the inner walls 25.

The insulating member 30 surrounds an outer periphery of the conductive member 40 when viewed in the direction of lamination and is in contact with the conductive member 40. In the present embodiment, the conductive member 40 has a columnar shape, and the insulating member 30 covers the entire side surface of the columnar conductive member 40 and is in contact with the side surface of the conductive member 40. A clearance may be provided at a certain part between the insulating member 30 and the conductive member 40.

The insulating member 30 and the conductive member 40 are packed together so as to bury the respective through holes 20 of the battery cells 100. The insulating member 30 completely buries a space between the inner walls 25 of the respective through holes 20 of the battery cells 100 and the conductive member 40, for example. For this reason, a shape of the insulating member 30 is the same as the shape of the respective through holes 20 of the battery cells 100 concatenated to one another except that a through hole to be penetrated by the conductive member 40 is formed at the center when viewed in the direction of lamination. In the present embodiment, the shape of the insulating member 30 is a tubular shape having a circular or polygonal circumference, for example. To be more precise, the shape of the insulating member 30 is an elongate truncated cone shape provided with the through hole to be penetrated by the conductive member 40 at the center when viewed in the direction of lamination. Note that the shape of the insulating member 30 is not limited to the aforementioned shape. The insulating member 30 is formed in conformity to the shapes of the through holes 20 and the conductive member 40, for example.

A thickness of the insulating member 30 is gradually increased from an end portion on the principal surface 12 side of the insulating member 30 toward an end portion on the principal surface 11 side of the insulating member 30. Since the battery cells 100 are laminated while being connected in series, a potential difference between the conductive member 40 that passes through the through hole 20 and is electrically connected to the principal surface 12 and the battery cell 100 at the corresponding position grows larger as a location between the conductive member 40 and the battery cell 100 is closer to the principal surface 11. Accordingly, the thickness of the insulating member 30 is larger in a region where the potential difference between the conductive member 40 and the battery cell 100, in other words, a voltage insulated by the insulating member 30 is larger. As a consequence, insulation reliability is enhanced so that reliability of the battery 1 can be improved. In the present embodiment, the thickness of the insulating member 30 is equal to a distance between the conductive member 40 and the inner wall 25. Details of the conductive member 40 will be described later.

The insulating member 30 is formed by using an insulating material having an electrical insulation property. For example, the insulating member 30 contains a resin. The resin is an epoxy-based resin, for example. However, the resin is not limited thereto. Here, an inorganic material may be used as the insulating material. The insulating material usable therein is selected based on various characteristics including flexibility, gas barrier properties, shock resistance, heat resistance, and the like.

The insulating member 30 is formed by filling the through hole 20 with the insulating material, molding the insulating material into the shape of the through hole 20, or coating the insulating material onto the inner wall 25, for example.

### 4. Conductive Members and Connecting Member

Next, the conductive member 40 and the connecting member 50 will be described.

The conductive member 40 is disposed inside the through holes 20. The conductive member 40 is electrically connected to the principal surface 12 of the power generation element 5 while interposing the connecting member 50 therebetween. For this reason, the conductive member 40 is electrically connected to the end portion layer current collector 150 on the negative electrode layer 120 of the lowermost battery cell 100, that is, to the negative electrode current collector 121.

The conductive member 40 extends from the opening position 22 of the through hole 20 at the principal surface 12 to the opening position 21 of the through hole 20 at the principal surface 11 while passing through the respective through holes 20 of the battery cells 100. The conductive member 40 penetrates from the principal surface 11 to the principal surface 12 of the power generation element 5 while passing through the respective through holes 20 of the battery cells 100. Accordingly, a potential at the negative electrode layer 120 of the battery cell 100 located lowermost is induced to the principal surface 11 side so that an electric current can be extracted from the lowermost battery cell 100 on the principal surface 11 side of the power generation element 5. That is to say, the conductive member 40 functions as a penetrating electrode that penetrates the power generation element 5. Accordingly, in the battery 1, both a positive electrode potential and a negative electrode potential of the entire power generation element 5 connected in series can be provided on the principal surface 11 side.

An end portion on the principal surface 11 side of the conductive member 40 is in contact with the current collecting terminal 51. An end portion on the principal surface 12 side of the conductive member 40 is in contact with the connecting member 50.

The insulating member 30 is disposed between the conductive member 40 and the inner walls 25. The conductive member 40 is not in contact with the positive electrode active material layer 112, the solid electrolyte layer 130, the negative electrode active material layer 122, the intermediate layer current collector 140, and the end portion layer current collector 150 on an upper end on the inner wall 25 of each of the through holes 20 of the battery cells 100. In other words, the conductive member 40 extends from the opening position 22 to the opening position 21 inside the through holes 20 while retaining insulation from the battery cells 100.

The conductive member 40 has a columnar shape, for example, but may have any other shapes such as a prism shape. A diameter of the conductive member 40 is constant, for example.

The conductive member 40 is formed by using a conductive resin material and the like. The conductive resin material contains metal particles and a resin, for example. Alternatively, the conductive member 40 may be formed by using a metal material such as aluminum, copper, nickel, stainless steel, and solder. The conductive material usable therein is selected based on various characteristics including flexibility, gas barrier properties, shock resistance, heat resistance, solder wettability, and the like. For example, the conductive member 40 can be formed in accordance with a method such as printing, plating, and molding.

The connecting member 50 is disposed on the principal surface 12 side of the power generation element 5. The connecting member 50 is connected to the conductive member 40 at the opening position 22. The connecting member 50 covers the principal surface 12 in the vicinity of the opening position 22 and is also connected to the principal surface 12. The connecting member 50 establishes electric connection between the conductive member 40 and the principal surface 12, that is, the negative electrode layer 120 of the battery cell 100 located lowermost.

The connecting member 50 is formed by using a conductive material. For example, the connecting member 50 is formed by using a metal material such as aluminum, copper, nickel, stainless steel, and solder. Alternatively, the connecting member 50 may be formed by using a conductive resin material and the like. For example, the connecting member 50 can be formed in accordance with a method such as printing, plating, and soldering. Alternatively, the connecting member 50 may be formed by drawing the conductive member 40 from the through hole 20 to outside of the principal surface 12 and being connected to the principal surface 12. In other words, the connecting member 50 may be a portion of the conductive member 40.

### 5. Current Collecting Terminals

Next, the current collecting terminal 51 and the current collecting terminal 55 will be described.

The current collecting terminal 51 is disposed on the principal surface 11 side of the power generation element 5. The current collecting terminal 51 is connected to the conductive member 40 at the opening position 21. In this way, the current collecting terminal 51 is electrically connected to the negative electrode layer 120 of the battery cell 100 located lowermost while interposing the conductive member 40 and the connecting member 50 therebetween. The current collecting terminal 51 is one of external connection terminals of the battery 1, which is a negative extraction terminal in the present embodiment. A portion of the current collecting terminal 51 is in contact with the insulating member 30. Here, the current collecting terminal 51 does not always have to be in contact with the insulating member 30. Alternatively, the current collecting terminal 51 may be connected to the conductive member 40 while interposing another conductive connecting layer or the like therebetween.

As illustrated in FIG. 2, the current collecting terminal 51 is located on an inner side of the through hole 20 in plan view of the principal surface 11, which is located on an inner side relative to an outer periphery of the insulating member 30 in the present embodiment. As a consequence, the current collecting terminal 51 is not in contact with the principal surface 11, and is insulated from the principal surface 11, that is, the positive electrode layer 110 of the battery cell 100 located uppermost.

The current collecting terminal 55 is disposed on the principal surface 11 side of the power generation element 5. As a consequence, the current collecting terminal 51 and the current collecting terminal 55 are provided on the same principal surface 11 side of the power generation element 5. The current collecting terminal 55 is disposed on the principal surface 11 and is connected to the principal surface 11. That is to say, the current collecting terminal 55 is electrically connected to the end portion layer current collector 150 at the positive electrode layer 110 of the uppermost battery cell 100, namely, to the positive electrode current collector 111. The current collecting terminal 55 is one of the external connection terminals of the battery 1, which is a positive extraction terminal in the present embodiment. Here, the current collecting terminal 55 may be connected to the principal surface 11 while interposing another conductive connecting layer or the like therebetween.

The current collecting terminal 51 and the current collecting terminal 55 are arranged in the x-axis direction in plan view, for example. A positional relationship between the current collecting terminal 51 and the current collecting terminal 55 is not limited to a particular relationship, and is designed depending on the wiring pattern and the like of the board on which the battery 1 is mounted, for example.

Each of the current collecting terminal 51 and the current collecting terminal 55 is a projecting terminal provided on the principal surface 11 side of the power generation element 5. However, shapes of the current collecting terminal 51 and the current collecting terminal 55 are not limited to particular shapes. The current collecting terminal 51 and the current collecting terminal 55 may undergo a required insulation treatment and then spread in a plate-like fashion along the principal surface 11.

Each of the current collecting terminal 51 and the current collecting terminal 55 is formed by using a conductive material. For example, each of the current collecting terminal 51 and the current collecting terminal 55 is formed by using a metal material such as aluminum, copper, nickel, stainless steel, and solder. Alternatively, each of the current collecting terminal 51 and the current collecting terminal 55 may be formed by using a conductive resin material and the like. For example, each of the current collecting terminal 51 and the current collecting terminal 55 can be formed in accordance with a method such as printing, plating, and soldering. Alternatively, the current collecting terminal 51 may be formed by causing the conductive member 40 to project from the through hole 20 to the outside of the principal surface 11. In other words, the current collecting terminal 51 may be a portion of the conductive member 40.

### 6. Usage Example

Next, a usage example of the battery 1 will be described. Note that the following usage example is a mere example and a mode of using the battery 1 is not limited to a particular method.

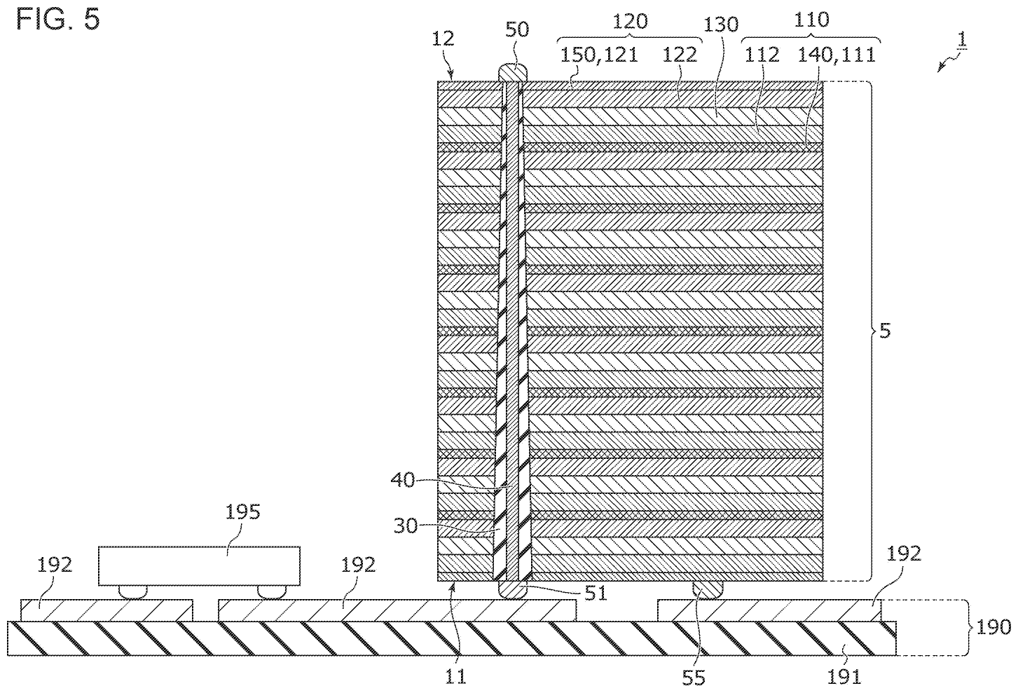

The battery 1 according to the present embodiment is used by being mounted on a circuit board, for example. FIG. 5 is a sectional view illustrating a usage example of the battery 1. FIG. 5 illustrates the battery 1 mounted on a circuit board 190, which is in a state of turning the battery 1 illustrated in FIG. 1 upside down.

As illustrated in FIG. 5, the circuit board 190 for mounting the battery 1 includes an insulative plate-like base body 191 and circuit wiring 192. The circuit wiring 192 is a circuit pattern formed on the base body 191.

The current collecting terminal 51 of the battery 1 is connected to a portion of the circuit wiring 192, for example. In the meantime, the current collecting terminal 55 of the battery 1 is connected to another different portion of the circuit wiring 192, for example. Thus, electric power is supplied from the battery 1 to an electronic device 195 mounted on the circuit board 190 and connected to the circuit wiring 192.

In the battery 1, the current collecting terminal 51 and the current collecting terminal 55 being the extraction terminals of the positive and negative electrodes are provided at the same principal surface 11. Since the current collecting terminal 51 and the current collecting terminal 55 are disposed on the inner side of the outer periphery of the power generation element 5 in plan view, the battery 1 can be mounted on the circuit board 190 with a minimum mounting area and a low profile.

Moreover, provision of the current collecting terminal 51 and the current collecting terminal 55 at the principal surface 11 can also shorten a wiring length of the circuit wiring 192 easily, so that wiring resistance and noise attributed to a current flowing on the wiring can be reduced.

Note that any of batteries according to respective embodiments to be described below may be mounted on the circuit board 190 instead.

### 7. Summary

As described above, according to the battery 1 of the present embodiment, the battery cells 100 are laminated while being connected in series. Thus, it is possible to realize the battery 1 that achieves the high capacity density and the high voltage.

Meanwhile, each of the battery cells 100 is provided with the through hole 20. The sectional area of the through hole 20 in the positive electrode layer 110 in the direction perpendicular to the direction of lamination is larger than the sectional area of the through hole 20 in the negative electrode layer 120 in the direction perpendicular to the direction of lamination. Thus, the through hole 20 can reduce the area of the positive electrode layer 110 as compared to the area of the negative electrode layer 120. Accordingly, it is possible to suppress precipitation and the like of the metal originating from the metallic ions that fail to be captured in the negative electrode layer 120, thereby enhancing reliability and safety of the battery 1. In particular, when the battery 1 is mounted on the board and the like as mentioned above, the battery 1 is seldom replaced or not replaced at all in many cases, and reliability under long-term specifications is important and improvement in reliability of the battery 1 is therefore of great significance.

In the meantime, in the battery 1, the through hole 20 can realize a difference in area between the positive electrode layer 110 and the negative electrode layer 120. Accordingly, it is not necessary to form each battery cell 100 by proving a difference in area between the positive electrode layer 110 and the negative electrode layer 120 in advance. For this reason, in the battery 1, it is possible to form the power generation element 5 having the flat side surfaces by cutting the laminated battery cells 100 in a lump, for example. Adoption of the lump cutting accurately determines the respective areas of the positive electrode layer 110, the negative electrode layer 120, and the solid electrolyte layer 130 while avoiding a gradual increase and a gradual decrease in film thickness at starting and terminating ends when coating each layer. In this way, it is possible to make maximum use of the capacity of each battery cell 100 and to increase the capacity density of the battery 1. Moreover, a variation in capacity among the battery cells 100 is reduced so that accuracy of a battery capacity can be enhanced.

In the meantime, the conductive member 40 passing through the through holes 20 can guide the potential at the principal surface 12 of the power generation element 5, that is to say, of the negative electrode layer 120 of the battery cell 100 located lowermost to the principal surface 11 side. In other words, both of the electric currents on the positive electrode and on the negative electrode of the power generation element 5 can be extracted on the principal surface 11 side. Accordingly, it is possible to assemble compact mounting of the battery 1. For example, a pattern of connection terminals (also referred to as footprints) to be formed on the board can be reduced in size. Moreover, it is possible to carry out mounting in a state of arranging the principal surface 11 of the battery 1 and the board in parallel, so that low profile mounting on the board can be realized. Reflow soldering and the like can be used for the mounting. As described above, it is possible to realize the battery 1 that is excellent in mountability.

Meanwhile, the conductive member 40 used for extracting the electric current from the principal surface 12 passes through the power generation element 5. Therefore, it is not necessary to form a structure required for extracting the electric current on the outside of a side surface of the power generation element 5. Accordingly, the battery 1 can be downsized so that the capacity density of the battery 1 can be increased. It is possible to reduce the mounting area when the battery 1 is mounted on the board, for example.

### Embodiment 2

Next, a description will be given of Embodiment 2. The following description will be focused on different features from those of the Embodiment 1 while omitting or simplifying explanations of features in common.

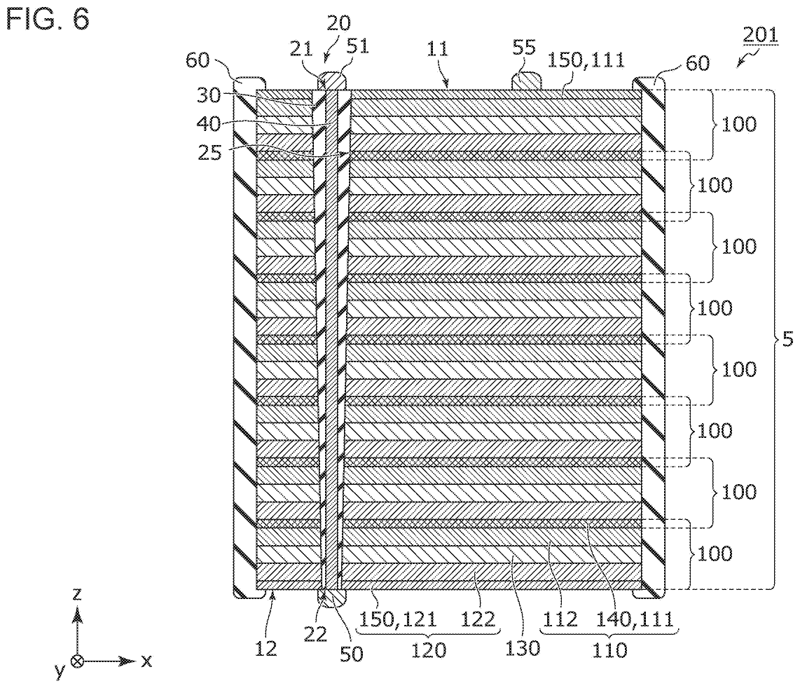

FIG. 6 is a sectional view of a battery 201 according to the present embodiment. As illustrated in FIG. 6, in comparison with the battery 1 according to the Embodiment 1, the battery 201 is different in that the battery 201 further includes a side surface insulating layer 60.

The side surface insulating layer 60 covers a side surface of the power generation element 5. The side surface insulating layer 60 covers all of the side surfaces of the power generation element 5, for example. This configuration can achieve suppression of collapse of the materials of the respective layers on the side surface of the power generation element 5, enhancement of weather resistance, enhancement of shock resistance, and the like, thereby improving reliability of the battery 201.

Alternatively, the side surface insulating layer 60 may cover respective end portions of the principal surface 11 and the principal surface 12. In this way, it is possible to suppress detachment of the end portion layer current collectors 150 disposed at the principal surface 11 and the principal surface 12, thereby further improving the reliability of the battery 201.

The side surface insulating layer 60 is formed by using an insulating material having an electrical insulation property. For example, the side surface insulating layer 60 contains a resin. The resin is an epoxy-based resin, for example. However, the resin is not limited thereto. Here, an inorganic material may be used as the insulating material. The insulating material usable therein is selected based on various characteristics including flexibility, gas barrier properties, shock resistance, heat resistance, and the like.

Note that the side surface insulating layer 60 may be provided to a battery according to each of the embodiments to be described later.

### Embodiment 3

Next, a description will be given of Embodiment 3. The following description will be focused on different features from those of the Embodiments 1 and 2 while omitting or simplifying explanations of features in common.

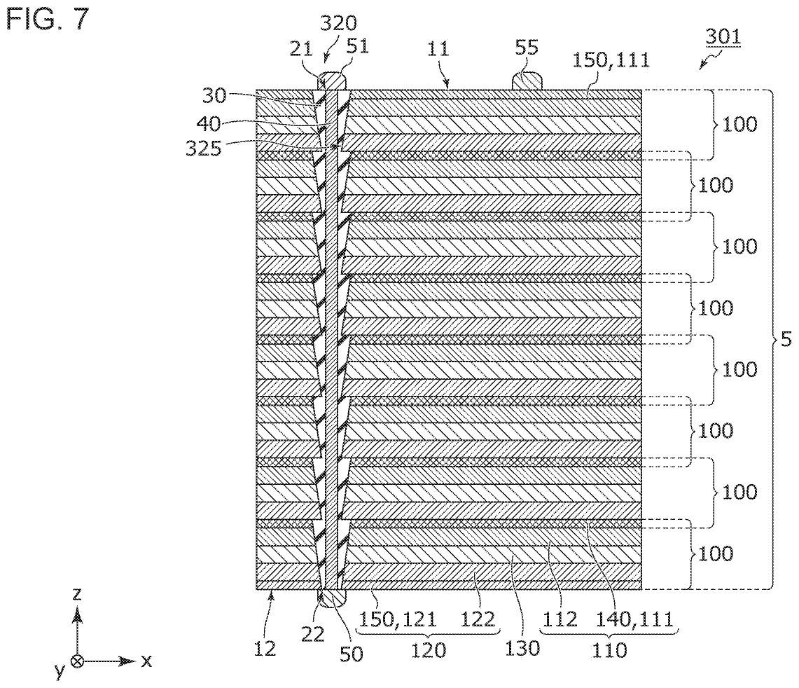

FIG. 7 is a sectional view of a battery 301 according to the present embodiment. As illustrated in FIG. 7, in comparison with the battery 1 according to the Embodiment 1, the battery 301 is different in that the battery cells 100 are provided with through holes 320 instead of providing the battery cells 100 with the through holes 20.

Each of the battery cells 100 is provided with the through hole 320. Regarding each of the through holes 320 in the battery cells 100, a sectional area of the through hole 320 in the positive electrode layer 110 in the direction perpendicular to the direction of lamination is larger than a sectional area of the through hole 320 in the negative electrode layer 120 in the direction perpendicular to the direction of lamination. Accordingly, the same effects as those of the above-described through holes 20 are available.

Moreover, the respective through holes 320 of the battery cells 100 have substantially the same volume and the same shape. Inner walls 325 of the respective through holes 320 of the battery cells 100 are inclined at the same angle with respect to the direction of lamination. Sectional areas of the through holes 320 in the respective positive electrode layers 110 of the battery cells 100 in the direction perpendicular to the direction are substantially equal. Meanwhile, sectional areas of the through holes 320 in the respective negative electrode layers 120 of the battery cells 100 in the direction perpendicular to the direction are substantially equal. Even when the through holes 320 are formed in the battery cells 100, respectively, the volumes of the respective battery cells 100 are likely to conform with one another because the volumes of the through holes 320 are equal, so that a variation in capacity among the battery cells 100 can be suppressed. For this reason, in charging or discharging the battery 301, it is easier to equalize operating voltages for the battery cells 100 that are laminated while being connected in series, and the occurrence of overcharge or overdischarge of a certain battery cell 100 is suppressed. Thus, reliability of the battery 301 can be improved. Particularly, in the case of a battery having a small size and a small area, the volumes of the through holes 320 have a larger impact. Accordingly, it is effective to equalize the volumes of the through holes 320.

Moreover, in the battery 1 according to the Embodiment 1, the inner walls 25 of the respective through holes 20 of the battery cells 100 collectively constitute the single continuous surface that is inclined with respect to the direction of lamination. On the other hand, the inner walls 325 of the respective through holes 320 of the battery cell 100 are not continuous but form a zigzag shape in the battery 301.

Meanwhile, as with the Embodiment 1, the respective through holes 320 of the battery cells 100 are concatenated to form the single through hole that penetrates the power generation element 5 in the direction of lamination. Moreover, the insulating member 30 and the conductive member 40 are disposed in the through holes 320. Accordingly, it is possible to realize the battery 301 having a high capacity density, high reliability, and high mountability as with the battery 1.

### Embodiment 4

Next, a description will be given of Embodiment 4. The following description will be focused on different features from those of the Embodiments 1 to 3 while omitting or simplifying explanations of features in common.

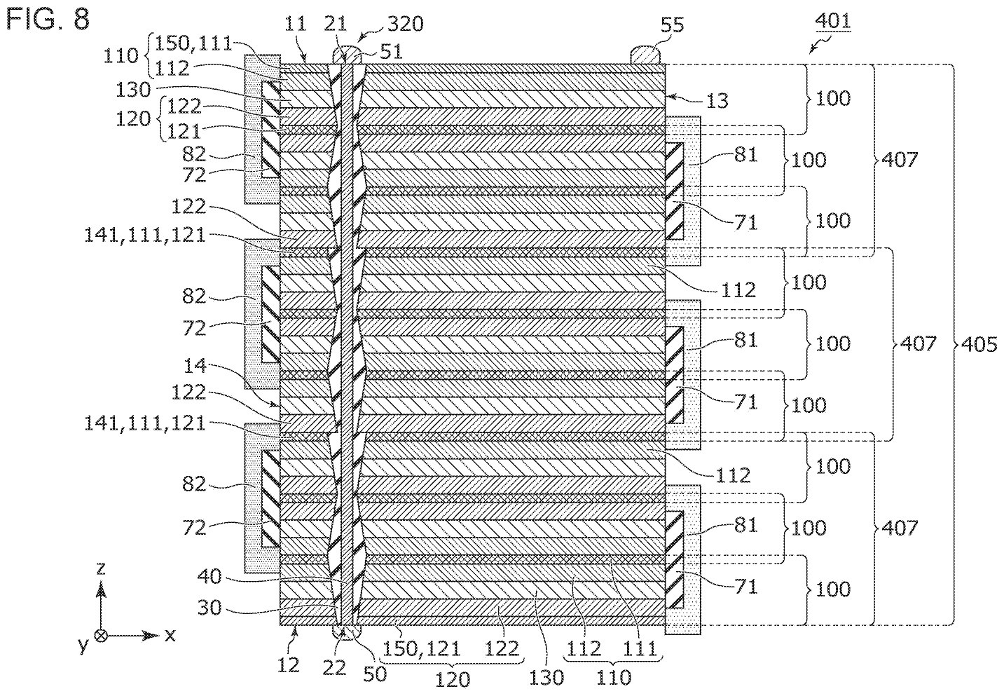

FIG. 8 is a sectional view of a battery 401 according to the present embodiment. As illustrated in FIG. 8, in comparison with the battery 301 according to the Embodiment 3, the battery 401 is different in that the battery 401 includes a power generation element 405 instead of the power generation element 5. Moreover, in comparison with the battery 301 according to the Embodiment 3, the battery 401 is also different in that the battery 401 further includes a positive electrode insulating layer 71, a negative electrode insulating layer 72, a negative electrode connecting portion 81, and a positive electrode connecting portion 82.

The power generation element 405 includes the battery cells 100. A portion of the battery cells 100 are laminated by being electrically connected in parallel. The power generation element 405 includes both the parallel connection and the serial connection of the battery cells 100.

To be more precise, the power generation element 405 includes parallel-laminated bodies 407. In the example illustrated in FIG. 8, the parallel-laminated bodies 407 each include odd, namely, three battery cells 100. The odd battery cells 100 included in each parallel-laminated body 407 are electrically connected in parallel. The parallel connection is carried out by the negative electrode connecting portion 81 and the positive electrode connecting portion 82. The parallel-laminated bodies 407 are electrically connected in series. The serial connection is carried out by laminating the parallel-laminated bodies 407 in the direction of lamination (that is, the z-axis direction) of the battery cells 100. A specific mode of connection will be described later. Here, the number of the parallel-laminated bodies 407 included in the power generation element 405 and the number of the battery cells 100 included in each parallel-laminated body 407 are not limited to particular numbers, which may each be an odd number or an even number. Alternatively, laminated bodies each including the battery cells 100 connected in series may be connected in parallel.

The power generation element 405 includes a side surface 13 and a side surface 14. The side surface 13 and the side surface 14 are back to back to each other and are parallel to each other. Each of the side surface 13 and the side surface 14 is a flat surface. The side surface 13 of the power generation element 405 is formed by connecting respective first side surfaces of the parallel-laminated bodies 407 in such a way as to be flush with one another. Likewise, the side surface 14 of the power generation element 405 is formed by connecting respective second side surfaces of the parallel-laminated bodies 407 in such a way as to be flush with one another.

As described above, in the battery 401, a large capacity is realized by forming the parallel-laminated bodies 407 each including the battery cells 100 that are laminated while being connected in parallel. Moreover, a large voltage is realized by connecting the parallel-laminated bodies 407 in series.

As illustrated in FIG. 8, regarding two battery cells 100 located adjacent to each other in the parallel-laminated body 407, the orders of arrangement of the respective layers constituting the battery cells 100 are reverse to each other. That is to say, the battery cells 100 are laminated in arrangement along the z axis while alternately reversing the orders of arrangement of the respective layers constituting the battery cells 100. In the present embodiment, the number of lamination of the battery cells 100 included in each parallel-laminated body 407 is an odd number. As a consequence, the lowermost layer and the uppermost layer of the parallel-laminated body 407 are the current collectors having different polarities from each other. In the example illustrated in FIG. 8, the lowermost layer of the parallel-laminated body 407 is the negative electrode current collector 121 of the negative electrode layer 120 and the uppermost layer thereof is the positive electrode current collector 111 of the positive electrode layer 110. Each of the three parallel-laminated bodies 407 has the same configuration.

As a consequence, it is possible to achieve the serial connection by laminating the parallel-laminated bodies 407 in the z-axis direction. Specifically, two parallel-laminated bodies 407 can be directly laminated in such a way that the current collectors having the different polarities are opposed to each other. That is to say, an insulating layer is not disposed between the parallel-laminated bodies 407 that are adjacent to each other in the direction of lamination. To be more precise, regarding the two parallel-laminated bodies 407 adjacent to each other, the positive electrode layer 110 being the uppermost layer of the parallel-laminated body 407 located below and the negative electrode layer 120 being the lowermost layer of the parallel-laminated body 407 located above share the current collector.

Each intermediate layer current collector 141 illustrated in FIG. 8 is a current collector shared by two parallel-laminated bodies 407. The intermediate layer current collector 141 functions as the positive electrode current collector 111 of one of the parallel-laminated body 407 and functions as the negative electrode current collector 121 of the other parallel-laminated body 407. To be more precise, the positive electrode active material layer 112 is disposed on the lower surface of the intermediate layer current collector 141 and the negative electrode active material layer 122 is disposed on the upper surface thereof.

Meanwhile, regarding two battery cells 100 adjacent to each other in each parallel-laminated body 407, two positive electrode layers 110 located adjacent to each other share one positive electrode current collector 111. That is to say, the positive electrode active material layers 112 are disposed on the upper surface and the lower surface of the single positive electrode current collector 111, respectively. Likewise, two negative electrode layers 120 located adjacent to each other share one negative electrode current collector 121. That is to say, the negative electrode active material layers 122 are disposed on the upper surface and the lower surface of the single negative electrode current collector 121, respectively.

The above-described power generation element 405 can be formed by using the battery cells 100A. 100B, and 100C illustrated in FIGS. 3A to 3C, for example.

Next, the positive electrode insulating layer 71 and the negative electrode insulating layer 72 will be described.

The positive electrode insulating layer 71 covers the positive electrode layer 110 on the first side surface of each of the parallel-laminated bodies 407. To be more precise, on the side surface 13 of the power generation element 405, the positive electrode insulating layer 71 covers the positive electrode layers 110, the solid electrolyte layers 130, and portions of the negative electrode active material layers 122 included in the respective parallel-laminated bodies 407. On the side surface 13, the positive electrode insulating layer 71 does not cover any of the negative electrode current collectors 121 included in the respective parallel-laminated bodies 407.

In each parallel-laminated body 407, the positive electrode layers 110 of the two adjacent battery cells 100 share the single positive electrode current collector 111. Accordingly, the positive electrode insulating layer 71 covers the two adjacent positive electrode layers 110 in a lump. Specifically, the positive electrode insulating layer 71 continuously covers a range from the negative electrode active material layer 122, the solid electrolyte layer 130, and the positive electrode active material layer 112 of one battery cell 100, the shared positive electrode current collector 111, the positive electrode active material layer 112, the solid electrolyte layer 130, and the negative electrode active material layer 122 of the other battery cell 100 regarding the two adjacent battery cells 100. As described above, since the positive electrode insulating layer 71 covers the solid electrolyte layers 130 and the negative electrode active material layers 122 in addition to the positive electrode layers 110, it is less likely to expose the positive electrode layers 110 to the side surface 13 even in case of a variation in width (a length in the z-axis direction) due to production tolerance of the positive electrode insulating layer 71. Accordingly, it is less likely that the positive electrode layer 110 comes into contact with the negative electrode connecting portion 81 on the side surface 13 to cause a short circuit, so that reliability of the battery 401 can be improved. Note that the positive electrode insulating layer 71 does not always have to cover the negative electrode active material layers 122. Meanwhile, the positive electrode insulating layer 71 does not always have to cover the solid electrolyte layers 130, either.

The negative electrode insulating layer 72 covers the negative electrode layer 120 on the second side surface of each of the parallel-laminated bodies 407. To be more precise, on the side surface 14 of the power generation element 405, the negative electrode insulating layer 72 covers the negative electrode layers 120, the solid electrolyte layers 130, and portions of the positive electrode active material layers 112 included in the respective parallel-laminated bodies 407. On the side surface 14, the negative electrode insulating layer 72 does not cover any of the positive electrode current collectors 111 included in the respective parallel-laminated bodies 407.

The positive electrode insulating layer 71 and the negative electrode insulating layer 72 penetrate into asperities on respective end surfaces of the positive electrode active material layers 112, the negative electrode active material layers 122, and the solid electrolyte layers 130, thereby increasing adhesion strength and improving reliability of the battery 401. Here, each of the positive electrode active material layers 112, the negative electrode active material layers 122, and the solid electrolyte layers 130 can be formed by using a powder material. In this case, very fine asperities are present on an end surface of each of the layers.

The positive electrode insulating layers 71 and the negative electrode insulating layers 72 form a stripe shape, respectively, when viewing the side surface 13 or the side surface 14 from the front, for example.

Each of the positive electrode insulating layer 71 and the negative electrode insulating layer 72 is formed by using an insulating material having an electrical insulation property. For example, each of the positive electrode insulating layer 71 and the negative electrode insulating layer 72 contains a resin. The resin is an epoxy-based resin, for example. However, the resin is not limited thereto. Here, an inorganic material may be used as the insulating material. The insulating material usable therein is selected based on various characteristics including flexibility, gas barrier properties, shock resistance, heat resistance, and the like. The positive electrode insulating layer 71 and the negative electrode insulating layer 72 are formed by using the same material. Instead, the positive electrode insulating layer 71 and the negative electrode insulating layer 72 may be formed by using different materials from each other.

In the present embodiment, of all the current collectors included in the power generation element 405, the intermediate layer current collectors 141, the uppermost positive electrode current collector 111 of the power generation element 405, and the lowermost negative electrode current collector 121 of the power generation element 405 are not covered with an insulating member on the side surface 13 and the side surface 14, respectively. The remaining current collectors included in the power generation element 405 are covered with the insulating member on any one of the side surfaces 13 and 14. The parallel-laminated bodies 407 can be connected in series by connecting the intermediate layer current collectors 141 to the negative electrode connecting portions 81 on the side surface 13 and to the positive electrode connecting portions 82 on the side surface 14.

Next, the negative electrode connecting portion 81 and the positive electrode connecting portion 82 will be described.

The negative electrode connecting portion 81 is a conductive portion which covers the first side surface and the positive electrode insulating layer 71 and is connected to the negative electrode layers 120 in each of the parallel-laminated bodies 407. In other words, the negative electrode connecting portion 81 is provided to each parallel-laminated body 407. As illustrated in FIG. 8, three negative electrode connecting portions 81 are provided in such a way as to cover the side surface 13. The three negative electrode connecting portions 81 are disposed at predetermined intervals so as not to come into contact with one another.

Specifically, the negative electrode connecting portions 81 come into contact with and cover the respective end surfaces of the negative electrode current collectors 121 on the side surface 13. In the present embodiment, each negative electrode connecting portion 81 also comes into contact with and covers at least a portion of each of the end surfaces of the negative electrode active material layers 122. The negative electrode connecting portions 81 penetrate into asperities on the end surfaces of the negative electrode active material layers 122, thereby increasing the adhesion strength and improving reliability of the battery 401.

The positive electrode connecting portion 82 is a conductive portion which covers the second side surface and the negative electrode insulating layer 72 and is connected to the positive electrode layers 110 in each of the parallel-laminated bodies 407. In other words, the positive electrode connecting portion 82 is provided to each parallel-laminated body 407. As illustrated in FIG. 8, three positive electrode connecting portions 82 are provided in such a way as to cover the side surface 14. The three positive electrode connecting portions 82 are disposed at predetermined intervals so as not to come into contact with one another.

Specifically, the positive electrode connecting portions 82 come into contact with and cover the respective end surfaces of the positive electrode current collectors 111 on the side surface 14. In the present embodiment, each positive electrode connecting portion 82 also comes into contact with and covers at least a portion of each of the end surfaces of the positive electrode active material layers 112. The positive electrode connecting portions 82 penetrate into asperities on the end surfaces of the positive electrode active material layers 112, thereby increasing the adhesion strength and improving reliability of the battery 401.

Here, each intermediate layer current collector 141 serves as the positive electrode current collector 111 and as the negative electrode current collector 121. The intermediate layer current collector 141 is in contact and covered with the negative electrode connecting portion 81 on the side surface 13, and is in contact and covered with the positive electrode connecting portion 82 on the side surface 14. In this instance, the negative electrode connecting portion 81 in contact with the intermediate layer current collector 141 is the negative electrode connecting portion 81 of the parallel-laminated body 407 that includes the intermediate layer current collector 141 as the negative electrode current collector 121 (that is to say, the parallel-laminated body 407 on the upper side in the example of FIG. 8). In this case, the negative electrode connecting portion 81 of the parallel-laminated body 407 on the upper side may be in contact with the positive electrode active material layer 112 of the parallel-laminated body 407 on the lower side. Likewise, the positive electrode connecting portion 82 in contact with the intermediate layer current collector 141 is the positive electrode connecting portion 82 of the parallel-laminated body 407 that includes the intermediate layer current collector 141 as the positive electrode current collector 111 (that is to say, the parallel-laminated body 407 on the lower side in the example of FIG. 8). In this case, the positive electrode connecting portion 82 of the parallel-laminated body 407 on the lower side may be in contact with the negative electrode active material layer 122 of the parallel-laminated body 407 on the upper side.

The negative electrode connecting portions 81 and the positive electrode connecting portions 82 form a stripe shape, respectively, when viewing the side surface 13 or the side surface 14 from the front, for example.

Each of the negative electrode connecting portion 81 and the positive electrode connecting portion 82 is formed by using a conductive resin material and the like. Alternatively, each of the negative electrode connecting portion 81 and the positive electrode connecting portion 82 may be formed by using a metal material such as solder. The conductive material usable therein is selected based on various characteristics including flexibility, gas barrier properties, shock resistance, heat resistance, solder wettability, and the like. The negative electrode connecting portion 81 and the positive electrode connecting portion 82 are formed by using the same material. Instead, the negative electrode connecting portion 81 and the positive electrode connecting portion 82 may be formed by using different materials from each other.

When drawing attention to a certain parallel-laminated body 407, the parallel connection of all of the battery cells 100 included in the certain parallel-laminated body 407 is carried out by the negative electrode connecting portion 81 provided on the first side surface of the certain parallel-laminated body 407 and the positive electrode connecting portion 82 provided on the second side surface of the certain parallel-laminated body 407. The parallel connection of the three battery cells 100 is carried out by the negative electrode connecting portion 81 and the positive electrode connecting portion 82 in each parallel-laminated body 407. Each of the negative electrode connecting portion 81 and the positive electrode connecting portion 82 can be realized with a small volume along the side surface 13 or the side surface 14 of the parallel-laminated body 407, so that the capacity density of the battery 401 can be increased. Moreover, since the power generation element 405 includes the serial connection and the parallel connection of the battery cells 100, it is possible to realize the high-capacity and high-voltage battery 401.

Meanwhile, the same through hole 320 as that in the Embodiment 3 is provided to each of the battery cells 100 in the power generation element 405 as well. Accordingly, a variation in capacity among the battery cells 100 can be suppressed as with the Embodiment 3.

In the meantime, the respective through holes 320 in the battery cells 100 are concatenated to form the single through hole that penetrates the power generation element 405 in the direction of lamination as with the Embodiment 1. Moreover, the insulating member 30 and the conductive member 40 are disposed in the through holes 320. Accordingly, it is possible to realize the battery 401 having the high capacity density, high reliability, and high mountability as with the Embodiment 1.

### Embodiment 5

Next, a description will be given of Embodiment 5. The following description will be focused on different features from those of the Embodiments 1 to 4 while omitting or simplifying explanations of features in common.

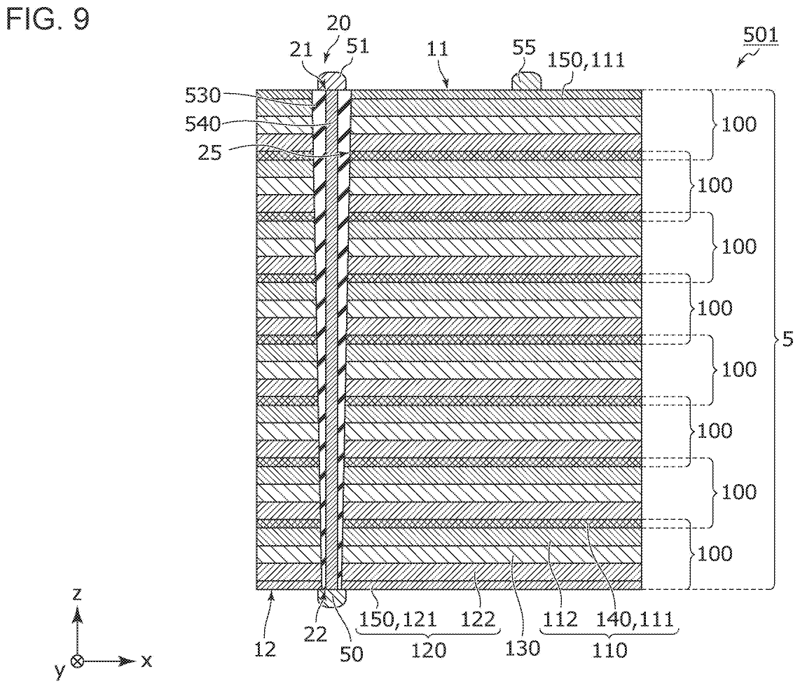

FIG. 9 is a sectional view of a battery 501 according to the present embodiment. As illustrated in FIG. 9, in comparison with the battery 1 according to the Embodiment 1, the battery 501 is different in that the battery 501 includes an insulating member 530 and a conductive member 540 instead of the insulating member 30 and the conductive member 40.

The insulating member 530 has the same features as those of the insulating member 30 except that its thickness is different from that of the insulating member 30. The thickness of the insulating member 530 is constant. Accordingly, a surface on the conductive member 540 side of the insulating member 530 is inclined with respect to the direction of lamination at the same angle as that of the inner walls 25 of the through holes 20. It is possible to increase options for the material of the insulating member 530 since the thickness of the insulating member 530 is constant as mentioned above. Meanwhile, when coating the insulating member 530 onto the inner walls 25 and curing the insulating member 530, it is possible to cure the insulating member 530 uniformly so that the highly reliable insulating member 530 can be formed. Moreover, the insulating member 530 can be inserted easily when forming the insulating member 530 by inserting the insulating member 530 into the through holes 20.

The conductive member 540 has the same features as those of the conductive member 40 except that its shape is a truncated shape instead of the columnar shape. The shape of the conductive member 540 is an elongate truncated cone shape, for example. However, the shape of the conductive member 540 may be any other shapes such as an elongate truncated pyramid shape. Since the thickness of the insulating member 530 is constant, the conductive member 540 is formed into such a shape that is in conformity to the shape of the through holes 20. Here, the conductive member 540 may have a columnar shape and a clearance may be provided between the conductive member 540 and the insulating member 530 for this purpose.

### Embodiment 6

Next, a description will be given of Embodiment 6. The following description will be focused on different features from those of the Embodiments 1 to 5 while omitting or simplifying explanations of features in common.

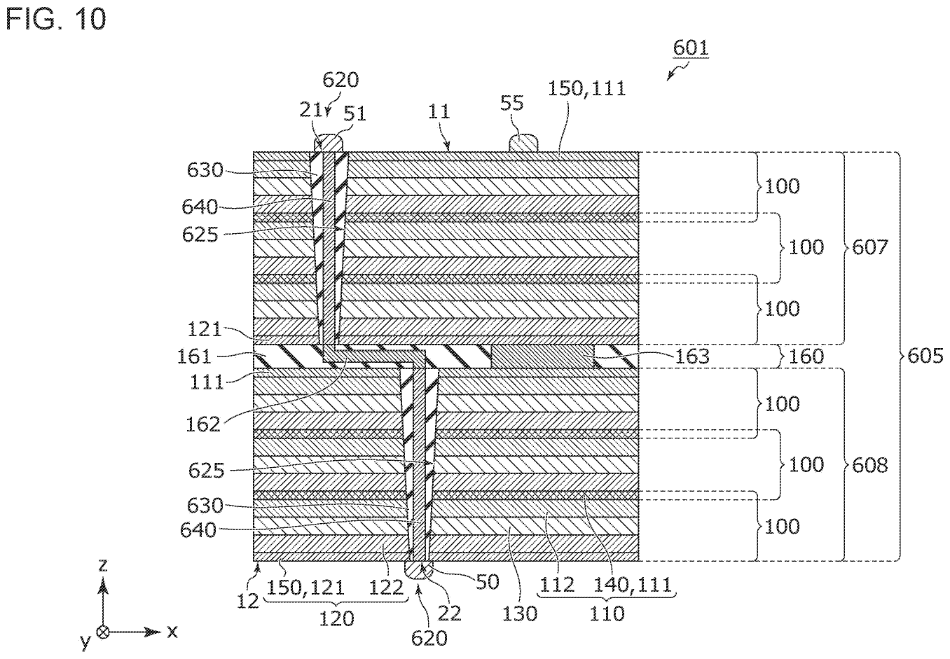

FIG. 10 is a sectional view of a battery 601 according to the present embodiment. As illustrated in FIG. 10, in comparison with the battery 1 according to the Embodiment 1, the battery 601 is different in that the battery 601 includes a power generation element 605, an insulating member 630, and a conductive member 640 instead of the power generation element 5, the insulating member 30, and the conductive member 40. Moreover, in comparison with the battery 1 according to the Embodiment 1, the battery 601 is also different in that through holes 620 are provided instead of the through holes 20.

The power generation element 605 includes the battery cells 100 and a connecting layer 160. In the power generation element 605, a portion of the battery cells 100 among the battery cells 100 constitute a cell laminated body 607 while another portion of the battery cells 100 among the battery cells 100 constitute a cell laminated body 608. The battery cells 100 constituting the cell laminated body 607 and the battery cells 100 constituting the cell laminated body 608 do not overlap one another. It is also possible to say that the power generation element 605 includes the cell laminated body 607 and the cell laminated body 608. The cell laminated body 607 is an example of a first cell laminated body. The cell laminated body 608 is an example of a second cell laminated body. In the example illustrated in FIG. 10, the cell laminated body 607 and the cell laminated body 608 each include multiple, namely, three battery cells 100. Here, the number of the cell laminated bodies included in the power generation element 605 and the number of the battery cells 100 included in each of the cell laminated body 607 and the cell laminated body 608 are not limited to particular numbers, respectively. The number of the battery cells 100 constituting the cell laminated body 607 may be equal to or different from the number of the battery cells 100 constituting the cell laminated body 608.

The battery cells 100 included in each of the cell laminated body 607 and the cell laminated body 608 are electrically connected in series. Meanwhile, the cell laminated body 607 and the cell laminated body 608 are electrically connected in series by using a conductive member 163 included in the connecting layer 160. Accordingly, all of the battery cells 100 of the power generation element 605 are electrically connected in series.

In the power generation element 605, each of the battery cells 100 is provided with a through hole 620 that penetrates each battery cell 100 in the direction of lamination. Regarding each of the through holes 620 in the battery cells 100, a sectional area of the through hole 620 in the positive electrode layer 110 in the direction perpendicular to the direction of lamination is larger than a sectional area of the through hole 620 in the negative electrode layer 120 in the direction perpendicular to the direction of lamination. Thus, the same effects as those of the through holes 20 according to the above-described Embodiment 1 are available.

In each of the cell laminated body 607 and the cell laminated body 608, the battery cells 100 are laminated in such a way as to concatenate the through holes 620. The respective through holes 620 of the battery cells 100 in the cell laminated body 607 collectively constitute a single through hole that penetrates the cell laminated body 607. Meanwhile, the respective through holes 620 of the battery cells 100 in the cell laminated body 608 collectively constitute a single through hole that penetrates the cell laminated body 608. By providing each of the cell laminated body 607 and the cell laminated body 608 with the single through hole as described above, it is possible to reduce a difference in area attributable to a difference in position in the direction of lamination regarding the cell laminated body 607 and the cell laminated body 608 as compared to the case of forming a single through hole in the battery cells 100 which are as many as those in the power generation element 605. Thus, it is possible to suppress a variation in capacity among the battery cells 100.

A position of the through holes 620 in the cell laminated body 607 is different from a position of the through hole 620 in the cell laminated body 608 when viewed in the direction of lamination. Accordingly, even when the number of the laminated battery cells 100 is increased and a problem is likely to occur as a consequence of forming the through holes at the same position of all of the battery cells 100, the through holes 620 can instead be formed while changing the positions thereof. Thus, it is possible to avoid a situation where it is difficult to form the insulating member and the like inside the through holes due to the increase in the number of the battery cells 100, for example.

The insulating member 630 are located inside the through holes 620. Each insulating member 630 is disposed between the conductive member 640 and inner walls 625 of the through holes 620. The insulating members 630 have the same features as those of the insulating member 30 except that the insulating members 630 are separately disposed in the respective through holes 620 of the battery cells 100 of the cell laminated body 607 and in the respective through holes 620 of the battery cells 100 of the cell laminated body 608, for example.

The conductive members 640 are located inside the through holes 620. Each conductive members 640 have the same features as those of the conductive member 40 except that the conductive members 640 are separately disposed in the respective through holes 620 of the battery cells 100 of the cell laminated body 607 and in the respective through holes 620 of the battery cells 100 of the cell laminated body 608, for example.

The connecting layer 160 is disposed between the cell laminated body 607 and the cell laminated body 608. The connecting layer 160 includes an insulating layer 161, and a conductive member 162 as well as the conductive member 163 which are disposed in the insulating layer 161.

The insulating layer 161 is disposed between the cell laminated body 607 and the cell laminated body 608. The insulating layer 161 is formed from an insulating material and insulates the conductive member 640 and the conductive member 162 from each of the cell laminated body 607 and the cell laminated body 608 in the connecting layer 160. Meanwhile, the insulating layer 161 is disposed between the conductive member 162 and the conductive member 163.

The conductive member 162 is buried in the insulating layer 161. The conductive member 162 is not in contact with the conductive member 163, the cell laminated body 607, and the cell laminated body 608. The conductive member 162 is connected to the conductive member 640 disposed in the through holes 620 of the cell laminated body 607 and to the conductive member 640 disposed in the through holes 620 of the cell laminated body 608. In this way, the two conductive members 640 are electrically connected to each other. Accordingly, electric currents of both the positive electrode and the negative electrode of the power generation element 605 can be extracted on the principal surface 11 side in the battery 601 as well.

The conductive member 163 is in contact with the positive electrode current collector 111 of the positive electrode layer 110 located at the uppermost of the cell laminated body 608 and with the negative electrode current collector 121 of the negative electrode layer 120 located at the lowermost of the cell laminated body 607. In this way, the cell laminated body 607 is electrically connected to the cell laminated body 608, whereby all of the battery cells 100 of the power generation element 605 are electrically connected in series.

Here, instead of the through holes 620, the respective battery cells 100 may be provided with the above-described through holes 320 having the same shape in the battery cells 100.

### Embodiment 7

Next, a description will be given of Embodiment 7. The following description will be focused on different features from those of the Embodiments 1 to 6 while omitting or simplifying explanations of features in common.

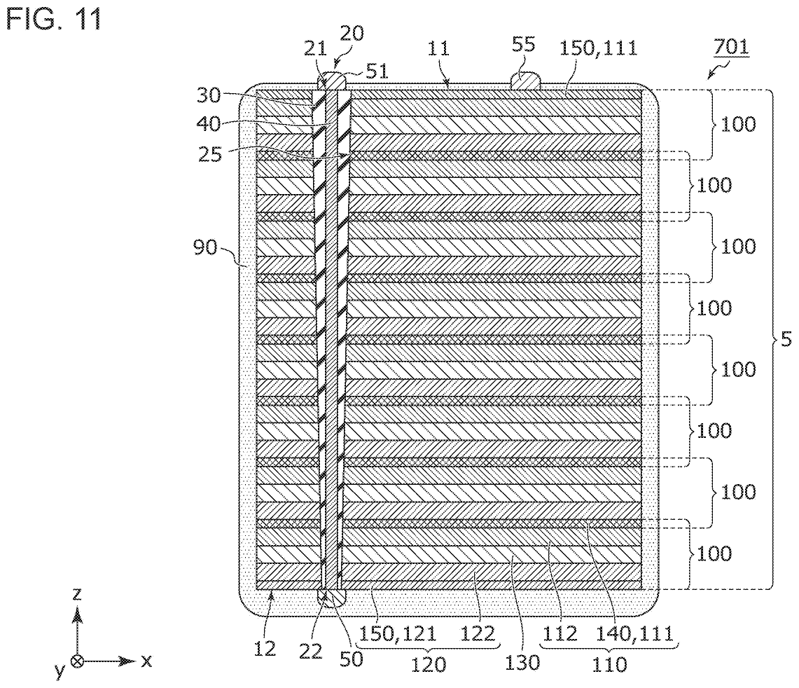

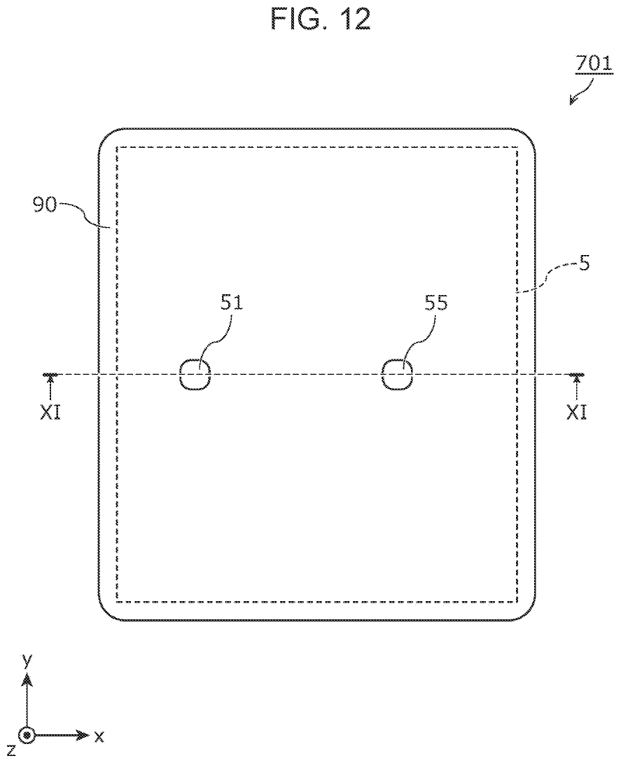

FIG. 11 is a sectional view of a battery 701 according to the present embodiment. FIG. 12 is a top plan view of the battery 701 according to the present embodiment. Here, FIG. 11 illustrates a section taken along the XI-XI line in FIG. 12. As illustrated in FIGS. 11 and 12, in comparison with the battery 1 according to the Embodiment 1, the battery 701 is different in that the battery 701 further includes a sealing member 90.

The sealing member 90 exposes at least a portion of each of the current collecting terminal 51 and the current collecting terminal 55 and seals the power generation element 5 at the same time. The sealing member 90 is provided in such a way as not to expose the power generation element 5, the insulating member 30, the conductive member 40, and the connecting member 50.

The sealing member 90 is formed by using an insulating material having an electrical insulation property, for example. Publicly known materials for battery sealing members such as a sealant can be used as the insulating material. A resin material can be used as the insulating material, for example. Here, the insulating material may be an insulative and non-ion conductive material. For example, the insulating material may be at least one of epoxy resin, acrylic resin, polyimide resin, and silsesquioxane.

Here, the sealing member 90 may contain different insulating materials. For example, the sealing member 90 may have a multilayer structure. Respective layers in the multilayer structure may be formed by using different materials and have different properties.

The sealing member 90 may contain a granular metal oxide material. Such metal oxide materials usable therefor include silicon oxide, aluminum oxide, titanium oxide, zinc oxide, cerium oxide, iron oxide, tungsten oxide, zirconium oxide, calcium oxide, zeolite, glass, and the like. For example, the sealing member 90 may be formed by using a resin material in which particles made of such a metal oxide material are dispersed.

A grain size of the metal oxide material is less than or equal to an interval between the positive electrode current collector 111 and the negative electrode current collector 121. A shape of grains of the metal oxide material is a spherical shape, an oval spherical shape, a rod shape, or the like but is not limited to these shapes.

Provision of the sealing member 90 can improve reliability of the battery 701 in various perspectives including mechanical strength, short-circuit prevention, moisture prevention, and so forth.

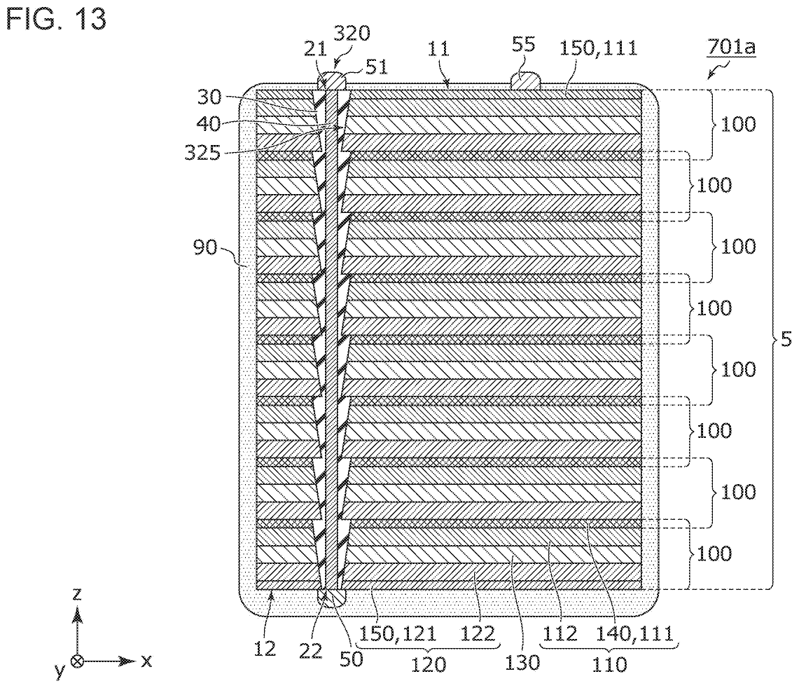

Although the example of further providing the battery 1 according to the Embodiment 1 with the sealing member 90 has been described herein, the batteries according to other embodiments may further include the sealing member 90 likewise. For example, the battery 301 according to the Embodiment 3 may further include the sealing member 90 as in a battery 701a illustrated in FIG. 13. FIG. 13 is a sectional view of the battery 701a according to another example of the present embodiment. In this case as well, the sealing member 90 exposes at least part of each of the current collecting terminal 51 and the current collecting terminal 55 while covering the power generation element 5, the insulating member 30, the conductive member 40, and the connecting member 50 so as not to expose these constituents.

### Embodiment 8

Next, a description will be given of Embodiment 8. The Embodiment 11 will describe a circuit board that includes the battery according to any of the above-described embodiments. The following description will be focused on different features from those of the Embodiments 1 to 7 while omitting or simplifying explanations of features in common.

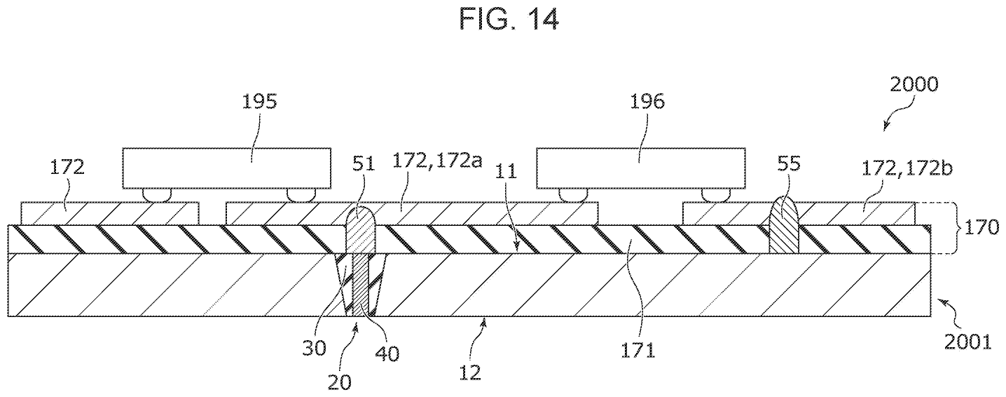

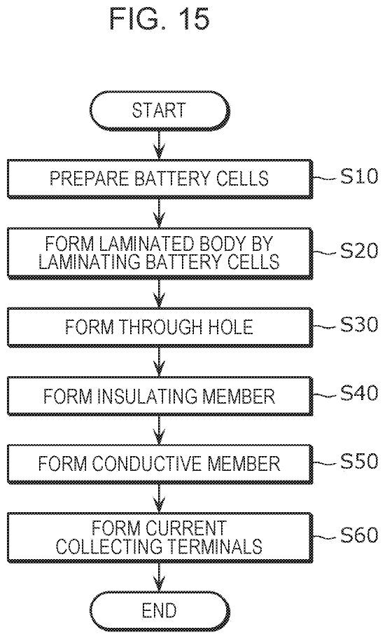

FIG. 14 is a sectional view of a circuit board 2000 according to the present embodiment. As illustrated in FIG. 14, the circuit board 2000 is a mounting board for mounting the electronic device 195 and an electronic device 196, for example. For example, each of the electronic device 195 and the electronic device 196 is any of a resistor, a capacitor, an inductor, a semiconductor chip, and the like. The number of the electronic devices to be mounted on the circuit board 2000 is not limited to a particular number.

The circuit board 2000 includes a battery 2001 and a circuit pattern layer 170.

The battery 2001 is any one of the batteries 1, 201, 301, 401, 501, 601, 701, and 701a according to the above-described embodiments. In FIG. 14, illustration of a detailed structure of the battery 2001 is omitted for the sake of visibility and only the through hole 20, the insulating member 30, the conductive member 40, the current collecting terminal 51 and the current collecting terminal 55 are demonstrated therein. Meanwhile, although the through hole 20, the insulating member 30, the conductive member 40 of the battery 1 according to the Embodiment 1 are representatively illustrated in FIG. 21, the battery 2001 may be provided with the through holes, the insulating members, and the conductive members according to any of the embodiments other than the Embodiment 1.

The circuit pattern layer 170 is laminated on the battery 2001. The circuit pattern layer 170 is disposed on the principal surface 11 side of the battery 2001. The circuit pattern layer 170 includes a wiring insulating layer 171 and circuit wiring 172.

The wiring insulating layer 171 is disposed on the principal surface 11. In the example illustrated in FIG. 14, a width (an area) of the wiring insulating layer 171 is equal to a width (an area) of the battery 2001. Instead, the width (the area) of the wiring insulating layer 171 may be smaller than or larger than the width (the area) of the battery 2001. The circuit wiring 172 is formed on a surface on the opposite side to the principal surface 11 side of the wiring insulating layer 171.

The wiring insulating layer 171 is formed from an insulating material, and a general board insulating member such as an insulating film or an insulating board can be used. Meanwhile, the wiring insulating layer 171 may be a coated layer of the insulating material coated on the battery 2001. Alternatively, the wiring insulating layer 171 may be a portion of the sealing member 90.

In the circuit board 2000, the current collecting terminal 51 and the current collecting terminal 55 penetrate the wiring insulating layer 171 and project from the opposite side to the principal surface 11 of the wiring insulating layer 171.

The circuit wiring 172 is disposed on the opposite side to the principal surface 11 side of the wiring insulating layer 171. The circuit wiring 172 is a circuit pattern formed on the wiring insulating layer 171. The circuit wiring 172 is general printed board wiring, for example. The circuit wiring 172 may be a conductive pattern formed in accordance with a different method. The electronic device 195 and the electronic device 196 are connected to the circuit wiring 172. The circuit wiring 172 includes a first line 172a and a second line 172b. The first line 172a is an example of a portion of the circuit wiring 172.

The current collecting terminal 51 and the current collecting terminal 55 are connected to the circuit wiring 172. Specifically, the current collecting terminal 51 is connected to the first line 172a. Meanwhile, the current collecting terminal 55 is connected to the second line 172b. Accordingly, the conductive member 40 is electrically connected to the first line 172a while interposing the current collecting terminal 51 therebetween. In the meantime, the principal surface 11 is electrically connected to the second line 172b while interposing the current collecting terminal 55 therebetween. The first line 172a and the second line 172b are located away from one another and are not in contact with one another.

In the circuit board 2000, the current collecting terminal 51 does not penetrate the circuit wiring 172 and a portion of the current collecting terminal 51 is buried in the circuit wiring 172. The current collecting terminal 55 penetrates the circuit wiring 172 and a tip end of the current collecting terminal 55 is exposed. Here, positional relationships of the current collecting terminal 51 and the current collecting terminal 55 with the circuit wiring 172 are not limited as long as these terminals are connected to the circuit wiring 172. For example, the current collecting terminal 51 may penetrate the circuit wiring 172. On the other hand, the current collecting terminal 55 does not always have to penetrate the circuit wiring 172. Meanwhile, a tip end of at least one of the current collecting terminal 51 and the current collecting terminal 55 may be in contact with a surface on the principal surface 11 side of the circuit wiring 172.

The circuit board 2000 is fabricated by forming the circuit pattern layer 170 and the battery 2001 separately and joining the circuit pattern layer 170 and the battery 2001 thus formed to each other, for example. Alternatively, the circuit board 2000 may be formed by laminating the wiring insulating layer 171 on the battery 2001 and then forming the pattern of the circuit wiring 172 on the laminated wiring insulating layer 171.

According to the above-described circuit board 2000, the electronic device 195 and the electronic device 196 can be mounted on the circuit pattern layer 170 that is formed on the battery 2001. Thus, the wiring board and the battery are integrated together, and downsizing and thin profiling of electronic equipment can be realized. Meanwhile, since the battery 2001 is one of the batteries according to the above-described embodiments, the battery 2001 can achieve a high capacity density and high reliability at the same time.

Meanwhile, the electric power can be directly supplied from the battery 2001 to required locations on the circuit wiring 172. Thus, it is possible to reduce extension of the wiring and to suppress radiation noise from the wiring. Moreover, the current collectors in the battery 2001 can function as shield layers for noise suppression. As described above, it is possible to stabilize an operation of the electronic equipment by using the circuit board 2000 for the electronic equipment. The circuit board 2000 is used for radio-frequency equipment susceptible to the radiation noise, for example.

Each of the conductive member 40 and the principal surface 11 is electrically connected to the circuit wiring 172 while interposing each of the current collecting terminal 51 and the current collecting terminal 55 therebetween. However, the present disclosure is not limited to this configuration. For example, conductive contacts that penetrate the wiring insulating layer 171 may be provided and the circuit wiring 172 may be electrically connected to the conductive member 40 and the principal surface 11 while interposing the conductive contacts therebetween.

### Manufacturing Method

Next, a description will be given of methods of manufacturing the batteries according to the respective embodiments mentioned above. Note that the manufacturing methods to be described below are mere examples and the methods of manufacturing the batteries of the above-described embodiments are not limited to the following examples. Meanwhile, the following description will be focused on manufacturing of the battery according to one of the above-mentioned embodiments. However, each of the manufacturing methods described below is applicable to the battery according to a different one of the embodiments as appropriate.

### First Example of Manufacturing Method

A first example of manufacturing the batteries according to the respective embodiments will be described to begin with.

FIG. 22 is a flowchart illustrating the first example of the method for manufacturing the batteries according to the respective embodiments. The first example of the manufacturing method will be focused on manufacturing of the battery 1 according to the Embodiment 1.

As illustrated in FIG. 22, the battery cells are prepared to begin with (step S10). The prepared battery cells are any of the battery cells 100A, battery cells 100B, and the battery cells 100C illustrated in FIGS. 3A to 3C, for example. In the following description of the manufacturing method, the battery cells 100A, 100B, and the 100C may be collectively referred to as the battery cells 100 as appropriate.

Next, a laminated body is formed by laminating the battery cells 100 (step S20). To be more precise, the laminated body is formed by sequentially laminating the battery cells 100 such that the orders of arrangement of the positive electrode layer 110, the negative electrode layer 120, and the solid electrolyte layer 130 in the respective battery cells are aligned with one another. The power generation element 5 illustrated in FIG. 4 is formed by laminating an appropriate combination of the battery cells 100A, 100B, and 100C, for example. The power generation element 5 is an example of the laminated body.

Here, the side surfaces of the power generation element 5 may be planarized after laminating the battery cells 100. The power generation element 5 with the respective flat side surfaces can be formed by cutting the laminated body of the battery cells 100 in a lump, for example. A cutting process is carried out by using a blade, a laser, waterjet, and the like.

Next, each of the battery cells 100 is provided with the through hole 20 that penetrates each battery cell 100 in the direction of lamination (step S30). In the formation of the through holes 20, each through hole 20 is formed such that the sectional area of the through hole 20 in the positive electrode layer 110 in the direction perpendicular to the direction of lamination is larger than the sectional area of the through hole 20 in the negative electrode layer 120 in the direction perpendicular to the direction of lamination in each of the battery cells 100. Thus, the through holes 20 are formed as illustrated in FIG. 1. When forming the through holes 20 in the truncated cone shape as described above, the through holes 20 are formed by cutting work with a drill and the like having a tapered angle, for example. Alternatively, the through holes 20 may be formed by using a laser and the like.

Meanwhile, in the first example of the manufacturing method, the through holes 20 are formed after the formation of the laminated body (step S20). Accordingly, the through holes 20 are provided in a lump in the respective laminated battery cells 100 by forming the through hole that penetrates the power generation element 5 in the direction of lamination, for example. In addition, it is not necessary to align positions in order to concatenate the respective through holes 20 of the battery cells 100. Thus, productivity in manufacturing the battery 1 can be improved. This is particularly effective in a case of manufacturing a large battery 1 that needs to increase positioning accuracy of the through holes associated with an increase in area of the power generation element 5. Moreover, the inner walls 25 of the respective through holes 20 of the battery cells 100 can be formed into a continuous surface easily.

Next, the insulating member 30 is formed in such a way as to be disposed between the inner walls 25 of the through holes 20 provided to the respective battery cells 100 and the conductive member 40 (step S40). For example, the insulating member 30 is formed in such a way as to cover the inner walls 25 of the through holes 20 provided to the respective battery cells 100. The insulating member 30 is formed in such a way as to provide a space for forming the conductive member 40 in the through holes 20 that are formed in the respective battery cells 100, for example. The insulating member 30 is formed by coating the insulating material on the inner walls 25 of the through holes 20, for example. Alternatively, the insulating member 30 may be formed by filling the through holes 20 with the insulating material in such a way as to completely bury the through holes 20, and providing the filled insulating material with a through hole for forming the conductive member 40, that is to say, a through hole having the same shape as that of the conductive member 40 to be formed therein.

Next, the conductive member 40 is provided so as to pass through the through holes 20 formed in the respective battery cells 100, thus penetrating the respective battery cells 100 (step S50). The conductive member 40 is formed by filling the spaces in the through holes 20 formed in the respective battery cells 100 and not provided with the insulating member 30 with a conductive material, for example. Alternatively, the conductive member 40 may be formed by inserting the conductive member 40 that is shaped by molding and the like in advance into the through holes 20, for example. In addition, the connecting member 50 is formed at the position to be connected to the end portion on the principal surface 12 side of the conductive member 40 and to the principal surface 12 when necessary.

Here, the formation of the insulating member 30 (step S40) and the formation of the conductive member 40 (step S50) need not be carried out in the aforementioned order. For example, the formation of the conductive member 40 (step S50) may be carried out before the formation of the insulating member 30 (step S40). In this case, the insulating member 30 and the conductive member 40 are formed inside the through hole 20 by disposing the conductive member 40 inside the through hole 20 and filling the space between the conductive member 40 and the inner wall 25 of the through hole 20 with the insulating member, for example. Alternatively, the formation of the insulating member 30 (step S40) and the formation of the conductive member 40 (step S50) may be carried out at the same time. In this case, the insulating member 30 and the conductive member 40 are formed inside the through hole 20 by inserting a composite member that integrates the insulating member 30 and the conductive member 40 together into the through hole 20. The composite member is a member in which the insulating member 30 is formed around the columnar conductive member 40, for example.

Next, the current collecting terminal 51 and the current collecting terminal 55 are formed (step S60). Specifically, the current collecting terminal 51 is formed at such a position that is connected to the end portion on the principal surface 11 side of the conductive member 40 and is not in contact with the principal surface 11. In the meantime, the current collecting terminal 55 is formed on the principal surface 11. The connecting member 50, the current collecting terminal 51, and the current collecting terminal 55 are formed by disposing the conductive material at desired regions by printing, plating, soldering, and the like.

The battery 1 illustrated in FIG. 1 can be manufactured by carrying out the above-described steps.

Meanwhile, the side surface insulating layer 60 illustrated in FIG. 6 may be formed at a certain timing after the formation of the laminated body (step S20). The side surface insulating layer 60 is formed by coating the insulating material on the side surfaces and the like of the power generation element 5, for example. The side surface insulating layer 60 may be formed by dipping a portion of the power generation element 5 into the insulating material in liquid form, and then curing the insulating material adhering to the power generation element 5. The curing is carried out by drying, heating, light irradiation, and the like depending on the resin material used therein.

In the meantime, the sealing member 90 illustrated in FIGS. 11 to 13 may be formed after the formation of the current collecting terminal 51 and the current collecting terminal 55 (step S60). The sealing member 90 is formed by coating the resin material having fluidity and then curing the resin material, for example. The coating is carried out in accordance with an ink jet method, a spray method, a screen printing method, a gravure printing method, and the like. The curing is carried out by drying, heating, light irradiation, and the like depending on the resin material used therein.

### Second Example of Manufacturing Method

Next, a second example of manufacturing the batteries according to the respective embodiments will be described. The following description will be focused on different features from those of the first example of the manufacturing method while omitting or simplifying explanations of features in common.

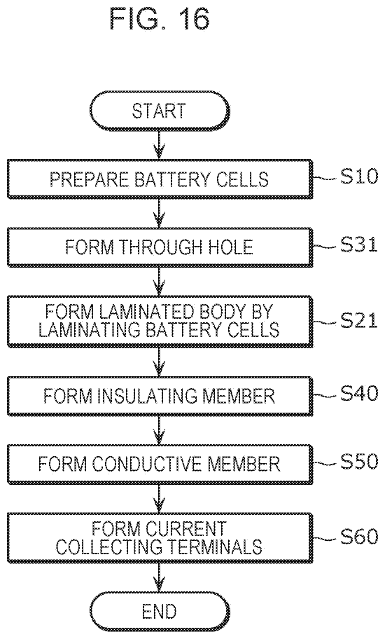

FIG. 16 is a flowchart illustrating the second example of the method for manufacturing the batteries according to the respective embodiments. The second example of the manufacturing method will be focused on manufacturing of the battery 301 according to the Embodiment 3. The second example of the manufacturing method has the different order of the respective steps from that of the first example of the manufacturing method.

As illustrated in FIG. 16, the battery cells are first prepared in accordance with the same method as that of the first example of the manufacturing method (step S10).

Next, the through holes 320 are formed in the respective battery cells 100 in such a way as to penetrate the respective battery cells 100 in the direction of lamination (step S31). For example, the through holes 320 having the same shape are individually formed in all of the battery cells 100. Since the through hole 320 can be provided to each battery cell 100 as described above, the through hole 320 can be formed easily, freedom of the shapes of the provided through holes 320 is increased. Through holes having different shapes may be formed in the battery cells 100, respectively. The method of forming the through holes 320 can adopt the same method as that in the first example of the manufacturing method.

Next, a laminated body is formed by laminating the battery cells 100 (step S21). In step S21, the battery cells 100 are laminated in such a way as to concatenate the through holes 320 provided to the respective battery cells 100.

Next, each of the formation of the insulating member 30 (step S40), the formation of the conductive member 40 (step S50), and the formation of the current collecting terminal 51 and the current collecting terminal 55 (step S60) is carried out in accordance with the same methods as those of the first example of the manufacturing method. Thus, it is possible to form the insulating member 30 and the conductive member 40 in a lump in the respective through holes 320 of the battery cells 100, respectively, so that productivity can be improved.

The battery 301 illustrated in FIG. 7 can be manufactured by carrying out the above-described steps.

### Third Example of Manufacturing Method

Next, a third example of manufacturing the batteries according to the respective embodiments will be described. The following description will be focused on different features from those of the first and second examples of the manufacturing method while omitting or simplifying explanations of features in common.

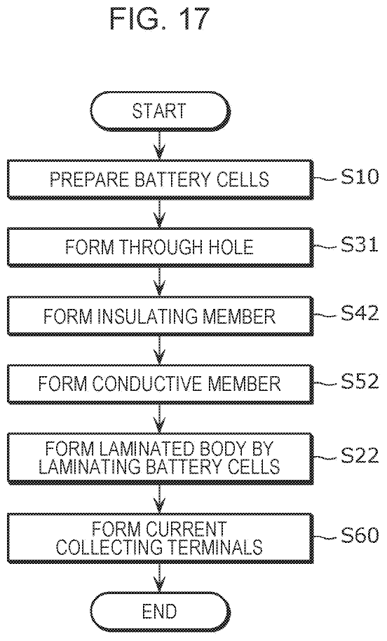

FIG. 17 is a flowchart illustrating the third example of the method for manufacturing the batteries according to the respective embodiments. The third example of the manufacturing method will be focused on the manufacturing of the battery 301 according to the Embodiment 6. The third example of the manufacturing method has the different order of the respective steps from those of the first and second examples of the manufacturing method.

As illustrated in FIG. 17, the battery cells are first prepared in accordance with the same method as that of the first example of the manufacturing method (step S10).

Next, the through holes 320 are formed in the battery cells 100, respectively, in such a way as to penetrate the respective battery cells 100 in the direction of lamination in accordance with the same method as that of the second example of the manufacturing method (step S31).

Next, the insulating member 30 is formed in such a way as to be disposed between the inner wall 325 of each of the through holes 320 provided to the battery cells 100 and the conductive member 40 (step S42). The insulating member 30 is individually formed in each of the through holes 320 provided to the respective battery cells 100.

Next, the conductive member 40 is provided so as to pass through each of the through holes 320 formed in the respective battery cells 100, thus penetrating the respective battery cells 100 (step S52). The conductive member 40 is individually formed in each of the through holes 320 provided to the respective battery cells 100.

The formation of the insulating member 30 and the conductive member 40 can adopt the same methods as those in the first example of the manufacturing method.

As described above, the insulating member 30 and the conductive member 40 can be formed in each of the through holes 320 before laminating the battery cells 100. Accordingly, it is easy to carry out an operation such as insertion of the materials into the through holes 320, so that the insulating members 30 and the conductive members 40 can be formed easily and accurately.

Next, a laminated body is formed by laminating the battery cells 100 (step S22). In step S22, the battery cells 100 are laminated in such a way as to concatenate the through holes 320 that are formed in the respective battery cells 100. In the meantime, the battery cells 100 are laminated such that the insulating members 30 and the conductive members 40 formed in the respective through holes 320 of the battery cells 100 are connected to one another, respectively.

Next, the current collecting terminal 51 and the current collecting terminal 55 are formed in accordance with the same method as that of the first example of the manufacturing method (step S60).

The battery 301 illustrated in FIG. 7 can be manufactured by carrying out the above-described steps.

### Fourth Example of Manufacturing Method

Next, a fourth example of manufacturing the batteries according to the respective embodiments will be described. The following description will be focused on different features from those of the first to third examples of the manufacturing method while omitting or simplifying explanations of features in common.

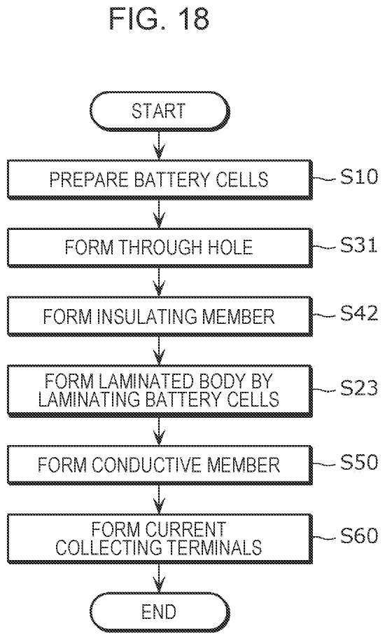

FIG. 18 is a flowchart illustrating the fourth example of the method for manufacturing the batteries according to the respective embodiments. The fourth example of the manufacturing method will be focused on the manufacturing of the battery 301 according to the Embodiment 3. The fourth example of the manufacturing method has the different order of the respective steps from those of the first to third examples of the manufacturing method.

As illustrated in FIG. 18, the battery cells are first prepared in accordance with the same method as that of the first example of the manufacturing method (step S10).

Next, the through holes 320 are formed in the battery cells 100, respectively, in such a way as to penetrate the respective battery cells 100 in the direction of lamination in accordance with the same method as that of the second example of the manufacturing method (step S31).

Next, the insulating member 30 is formed in such a way as to be disposed between the inner wall 325 of each of the through holes 320 provided to the battery cells 100 and the conductive member 40 in accordance with the same method as that of the third example of the manufacturing method (step S42). In this way, it is possible to form the insulating member 30 easily and accurately, which is required to be formed accurately in order to improve reliability of the battery 301.

Next, a laminated body is formed by laminating the battery cells 100 (step S23). In step S23, the battery cells 100 are laminated in such a way as to concatenate the through holes 320 that are formed in the respective battery cells 100. In the meantime, the battery cells 100 are laminated such that the insulating members 30 formed in the respective through holes 320 of the battery cells 100 are connected to one another. Meanwhile, in the case where the insulating members 30 are provided with the through holes for forming the conductive members 40 therein, the battery cells 100 are laminated in such a way as to concatenate the through holes in the insulating members 30.

Here, in the formation of the insulating members 30 (step S42), the insulating members 30 may be formed by filling the through holes 320 with the insulating material in such a way as to completely bury the through holes 320, and providing the filled insulating material with the through holes for forming the conductive members 40. In this case, the formation of the through holes for providing the conductive members 40 may be carried out before the formation of the laminated body (step S23) or after the formation of the laminated body (step S23) on the battery cells 100 in a lump.

Next, the formation of the conductive members 40 (step S50) and the formation of the current collecting terminal 51 and the current collecting terminal 55 (step S60) is carried out in accordance with the same methods as those of the first example of the manufacturing method.

The battery 301 illustrated in FIG. 7 can be manufactured by carrying out the above-described steps.

### Other Embodiments

The battery, the method for manufacturing the battery, and the circuit board according to one or more aspects have been described above based on the embodiments. However, the present disclosure is not limited to these embodiments. Various modifications that can be conceived of by those skilled in the art and are adopted to any of these embodiments as well as other aspects constructed by combining certain constituents out of the embodiments are also encompassed by the scope of the present disclosure as long as those modifications and modes do not depart from the gist of the present disclosure.

For example, the above-described embodiments depict the example in which the single current collector is shared by the battery cells located adjacent to each other as any of the intermediate layer current collector, the positive electrode current collector, and the negative electrode current collector. However, the current collector does not need to be shared. Here, two adjacent battery cells may be laminated together while joining two current collector to each other. The intermediate layer current collector may be formed by overlapping the negative electrode current collector with the positive electrode current collector, for example.

Meanwhile, in the above-described embodiments, the battery is provided with the conductive member and the insulating member, for example. However, the present disclosure is not limited to this configuration. At least one of the conductive member and the insulating member need not be provided to the battery. When the battery does not include the conductive member, the through hole is used as a hole for passing a conducting wire, a communication wire and the like or as a hole for fastening to electronic equipment, for example.

In the meantime, in the above-described embodiments, the power generation element includes the multiple battery cells, for example. However, the present disclosure is not limited to this configuration. The power generation element may be formed from a single battery cell.

Meanwhile, in the above-described embodiments, the inner wall of each through hole is inclined with respect to the direction of lamination, for example. However, the present disclosure is not limited to this configuration. The sectional area of the through hole in the positive electrode layer may be formed larger than the sectional area of the through hole in the negative electrode layer by providing the inner wall of the through hole with steps.

In the meantime, in the above-described embodiments, the sectional area on the first principal surface side of the through hole is larger than the sectional area on the second principal surface side of the through hole. However, the present disclosure is not limited to this configuration. The order of lamination of the respective layers in each of the battery cells 100 may be turned upside down so as to dispose the positive electrode layer on the second principal surface side, thereby forming a structure in which the sectional area on the second principal surface side of the through hole is larger than the sectional area on the first principal surface side of the through hole.

Meanwhile, in any of the above-described embodiments, an external electrode may further be formed on any of the current collecting terminals by plating, printing, soldering, and the like, for example. The formation of the external electrode can further enhance mountability of the battery, for example.

Meanwhile, in the above-described embodiments, the insulating layer completely buries the space between the conductive member and the inner wall of the through hole, for example. However, the present disclosure is not limited to this configuration. The insulating member may cover the inner wall of the through hole while being located away from the conductive member. Alternatively, the insulating member may cover an outer peripheral surface of the conductive member while being located away from the inner wall of the through hole.

In the meantime, a relationship of connection among the battery cells in the power generation element is not limited to the examples described in the embodiments. For example, all of the battery cells may be connected in parallel, or the battery cells may involve an arbitrary combination of the serial connection and the parallel connection.

Meanwhile, the battery includes the current collecting terminals in the above-described embodiments, for example. However, the present disclosure is not limited to this configuration. The battery does not always have to include the current collecting terminals. For example, a current may be extracted by connecting terminals of an electronic device, contacts of a board, pads of the board, and the like to the conductive members and the principal surfaces of the power generation element.

Meanwhile, the respective embodiments described above can implement a variety of modification, replacement, addition, omission, and the like within the scope of the appended claims and the equivalents thereof.

The present disclosure is applicable to a battery or a circuit board for electronic equipment, electric appliances, and electric vehicles, for example.

What is claimed is:

1. A battery comprising:
a power generation element including at least one battery cell each having a laminated structure of a positive electrode layer, a negative electrode layer, and a solid electrolyte layer located between the positive electrode layer and the negative electrode layer, wherein
the at least one battery cell is each provided with a through hole penetrating in a direction of lamination,
a sectional area of the through hole in the positive electrode layer in a direction perpendicular to the direction of lamination is larger than a sectional area of the through hole in the negative electrode layer in the direction perpendicular to the direction of lamination, and
an inner wall of the through hole is inclined with respect to the direction of lamination.

2. The battery according to claim 1, wherein
in the power generation element, the through hole of the at least one battery cell is open on a first principal surface and a second principal surface on an opposite side to the first principal surface of the power generation element, respectively, and
the battery further includes a conductive member being electrically connected to the second principal surface of the power generation element and extending from an opening position of the through hole at the second principal surface to an opening position of the through hole at the first principal surface while passing through the through hole.

3. The battery according to claim 2, further comprising:
an insulating member located between the conductive member and the inner wall of the through hole.

4. The battery according to claim 3, wherein the insulating member covers the inner wall of the through hole.

5. The battery according to claim 1, wherein the through hole has a truncated cone shape.

6. The battery according to claim 1, wherein
the at least one battery cell includes a plurality of battery cells, and
the plurality of battery cells are laminated.

7. The battery according to claim 6, wherein at least a portion of the plurality of battery cells are laminated while being electrically connected in parallel.

8. The battery according to claim 6, wherein the plurality of battery cells are laminated while being electrically connected in series.

9. The battery according to claim 6, wherein volumes of the respective through holes of the plurality of battery cells are equal.

10. The battery according to claim 8, wherein the inner walls of the respective through holes of the plurality of battery cells form a continuous surface inclined with respect to the direction of lamination.

11. The battery according to claim 6, wherein the respective through holes of the plurality of battery cells are concatenated.

12. The battery according to claim 6, wherein
in the power generation element,
a portion of the plurality of battery cells constitute a first cell laminated body by being laminated in such a way as to concatenate the through holes,
another portion of the plurality of battery cells constitute a second cell laminated body by being laminated in such a way as to concatenate the through holes, and
a position of the through holes in the first cell laminated body is different from a position of the through holes in the second cell laminated body when viewed in the direction of lamination.

13. A method for manufacturing a battery comprising:
forming a laminated body by laminating a plurality of battery cells;
forming a through hole in each of the plurality of battery cells in such a way as to penetrate in a direction of lamination;
forming a conductive member that passes through the through hole formed in each of the plurality of battery cells and penetrates each of the plurality of battery cells; and
forming an insulating member to be disposed between an inner wall of the through hole formed in each of the plurality of battery cells and the conductive member, wherein
the through hole is formed in the forming a through hole such that a sectional area of the through hole in a positive electrode layer in a direction perpendicular to the direction of lamination is larger than a sectional area of the through hole in a negative electrode layer in the direction perpendicular to the direction of lamination.

14. The method for manufacturing a battery according to claim 13, wherein the forming a through hole is carried out after the forming a laminated body.

15. The method for manufacturing a battery according to claim 13, wherein
in the forming a laminated body, the plurality of battery cells are laminated in such a way as to concatenate the respective through holes of the plurality of battery cells after the forming a through hole; and
each of the forming an insulating member and the forming a conductive member is carried out after the forming a laminated body.

16. The method for manufacturing a battery according to claim 13, wherein each of the forming a through hole, the forming an insulating member, and the forming a conductive member is carried out before the forming a laminated body.

17. The method for manufacturing a battery according to claim 13, wherein
each of the forming a through hole and the forming an insulating member is carried out before the forming a laminated body, and
the forming a conductive member is carried out after the forming a laminated body.

18. A circuit board comprising:
a power generation element including at least one battery cell each having a laminated structure of a positive electrode layer, a negative electrode layer, and a solid electrolyte layer located between the positive electrode layer and the negative electrode layer;
a conductive member; and
a circuit pattern layer being laminated on the power generation element and including circuit wiring, wherein
the at least one battery cell is each provided with a through hole penetrating in a direction of lamination,
a sectional area of the through hole in the positive electrode layer in a direction perpendicular to the direction of lamination is larger than a sectional area of the through hole in the negative electrode layer in the direction perpendicular to the direction of lamination,
in the power generation element, the through hole of the at least one battery cell is open on a first principal surface and a second principal surface on an opposite side to the first principal surface of the power generation element, respectively,
the conductive member is electrically connected to the second principal surface of the power generation element, extends from an opening position of the through hole at the second principal surface to an opening position of the through hole at the first principal surface while passing through the through hole, and is electrically connected to a portion of the circuit wiring, and
the circuit pattern layer is located on the first principal surface side of the power generation element.
